(19) United States
(12) Patent Application Publication
(10) Pub. No.: US 2002/0105491 A1
(43) Pub. Date: Aug. 8, 2002

(54) Display apparatus displaying pseudo gray levels and method for displaying the same

(75) Inventors: Machihiko Yamaguchi, Tokyo (JP); Youji Hirano, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 09/987,600

(22) Filed: Nov. 15, 2001

(30) Foreign Application Priority Data
Nov. 24, 2000 (JP) 2000-358411

(51) Int. Cl. G09G 3/36

(52) U.S. Cl. 345/89

(57) ABSTRACT

A display apparatus is composed of a pseudo gray level data processor generating pseudo gray level data having m bits based on input gray level data having n bits. The pseudo gray level data processor includes a state variable generator generating a state variable data having n−m bits, based on lower n−m bits of the input gray level data, an adder calculating a sum of the lower n−m bits of the input gray level data and the state variable data to output a carry bit representative of carry-over of the sum, and a pseudo gray level data calculator generating the pseudo gray level data based on the input gray level data and the carry bit. The pseudo gray level data calculator defines the pseudo gray level data such that the pseudo gray level data equals upper m bits of the input gray level data in a first case when the carry bit is “0” and the input gray level belongs to first gray levels of the 2ⁿ gray levels, and such that upper m−1 bits of the pseudo gray level data equals upper m−1 bits of the input gray level data and LSB (least significant bit) of the pseudo gray level data is selected from “0” and “1” in a second case when the carry bit is “1” and the input gray level data belongs to the first gray levels.

### BACKGROUND OF THE INVENTION

1. Field of the Invention

The present invention is related to a display apparatus. More particularly, the present invention is related to a display apparatus displaying pseudo gray levels or shades and method for displaying the same.

2. Description of the Related Art

A large number of gray levels are requested for improving the quality of pictures displayed by display devices such as LCD (Liquid Crystal Display) and PDP (Plasma Display Panel). However, the limited number of gray levels are available in the display devices.

A pseudo gray level method is often used for increasing the number of displayable gray levels. The pseudo gray level method generates an m-bit gray level signal from an original n-bit gray level signal (n being larger than m) to enable the display which can physically display 2ⁿ gray levels to display 2ⁿ gray levels in appearance.

A pseudo gray level processor for implementing the pseudo gray level method is disclosed by Matsunaga et al. in Japanese Laid Open Patent Application (JP-A-Heisei 9-90902). The conventional pseudo gray level processor implements the error diffusion method for displaying pseudo gray levels. The conventional pseudo gray level processor is provided with a one-dot delay circuit 151, a first adder 152, an error diffusion calculating circuit 156 and a calculatingly initial value setting circuit 170, as shown in FIG. 1. The error diffusion calculating circuit 156 is composed of a second adder 158, a one-dot delay circuit 160, a switching circuit 162, a calculation control circuit 164 and a threshold setting circuit 168. The calculatingly initial value setting circuit 170 is composed of an initial value setting ROM 172, a line counter 174 and a frame counter 176.

The error diffusion calculating circuit 156 carries out an error diffusion calculation on the basis of a lower bit data A which is lower (n−m) bits of an n-bit (for example, 8-bit) input picture data. The calculation control circuit 164 calculates a value δ by

δ=D−S,

where D is a value sent from the one-dot delay circuit 160, and S is a threshold sent from the threshold setting circuit 168. Then the calculation control circuit 164 sends “1” as a carry value E to the first adder 152 when the value δ is 0 or more.

The first adder 152 adds the carry value E and data B that is upper m bits (for example, 5 bits) of the picture signal to generate a pseudo gray level data F. The first adder 152 outputs the pseudo gray level data F to a display panel.

The initial value setting circuit 170 sends an initial value of the error diffusion calculating circuit 156. The initial value is different for each line of the display panel to erase the directivity of a diffusion pattern. Moreover, the pseudo gray level processor does not require a line memory for each line of the display panel.

However, the number of gray levels that can be represented by the pseudo gray level data F is smaller than the number of gray levels that can be represented by an input picture data A. The reason is as follows. If all the upper m bits of the input picture data A are “1”, all the bits of the pseudo gray level data F are “1” for any values of the lower bits (n−m) of the input picture data A. The number of gray level in which the upper m bits are all “1” is 2(n−m). When the input picture data representative of any of the 2(n−m) gray levels is inputted, the pseudo gray level data F have the value in which all the bits are “1”. Therefore, the pseudo gray level data F can represent only 2ⁿ−2^{(n-m)}+1 gray levels. The pseudo gray level processor desirably allows the pseudo gray level data of m bits to represent all the 2ⁿ gray levels for n larger than m.

Frame rate control is another typical technique for increasing displayable gray levels. A frame rate control method is disclosed by Miyatake in Japanese Laid Open Patent Application (Jp-A-Heisei 7-120725). Miyatake describes a method for driving a LCD in which a gray level signal applied to an LCD pixel is switched every frame and has different signs and effective voltages for former n frames and latter n frames of successive 2n frames.

Still another technique which may be related to the present invention is disclosed by Furuhashi et al. in Japanese Laid Open Patent Application (Jp-A-Heisei 9-106267). Furuhashi et al. disclose the LCD for increasing contrast. One electrode of each LCD pixel is a drive electrode driven by a LCD driver, and another is a common plate electrode. The LCD includes a plate electrode driver for driving the plate electrode. The plate electrode driver latches the upper bits of the gray level data, and outputs one of predetermined voltages in response to the upper bits. The plate electrode driver allows the LCD pixels to be applied with a voltage larger than a dynamic range of the LCD driver, and increase the contrast of the LCD. However, Furuhashi et al. does not describe the pseudo gray levels.

### SUMMARY OF THE INVENTION

Therefore, the object of the present invention is to provide an improved method for displaying pseudo gray levels.

More particularly, the object of the present invention is to provide a pseudo gray level processor which allows the pseudo gray level data of m bits to represent all the 2ⁿ gray levels for n larger than m.

Another object of the present invention is to object of the present invention is to provide a pseudo gray level processor for generating an m-bit pseudo gray level signal from an n-bit input gray level signal (n being larger than n) such that a fixed pattern is hard to be induced in a picture displayed by a display apparatus.

In order to achieve an aspect of the present invention, a display apparatus is composed of a pseudo gray level data processor. The pseudo gray level data processor generates pseudo gray level data having m bits based on input gray level data having n bits representative of an input gray level of 2ⁿ gray levels, where n is a natural number equal to or more than 2, and m is a natural number less than n. The pseudo gray level data processor includes a state variable generator, an adder and a pseudo gray level data generator. The state variable generator generates a state variable data having n−m bit(s) on the basis of lower n−m bit(s) of the input gray level data. The adder calculates a sum of the lower n−m bit(s) of the input gray level data and the state variable data, and outputs a carry bit representative of carry-over of the sum. The pseudo gray level data generator generates the pseudo gray level data based on the input gray level data and the carry bit. In a first case when the carry bit is “0” and the input gray level belongs to first gray levels of the 2ⁿ gray levels, the pseudo gray level data generator defines the pseudo gray level data such that the pseudo gray level data equals upper m bits of the input gray level data in a first case. In a second case when the carry bit is “1” and the input gray level data belongs to the first gray levels, the pseudo gray level data generator defines the pseudo gray level data such that upper m−1 bit(s) of the pseudo gray level data equals upper m−1 bit(s) of the input gray level data and the LSB (least significant bit) of the pseudo gray level data is selected from “0” and “1”.

It is desirable that upper m−1 bit(s) of the input gray level data are “1” and the m-th significant bit of the input gray level data is “0” when the input gray level data represents any one of the first gray levels.

In addition, a first probability of the LSB of the pseudo gray level data being “0” in the second case substantially equals a second probability of the LSB of the pseudo gray level data being “1” in the second case.

When the display apparatus further includes a pixel matrix unit including pixels displaying a displaying gray level indicated by the pseudo gray level data, the pseudo gray level data generator preferably determines the LSB of the pseudo gray level data in response to a position of the pixels in the pixel matrix unit.

When the pixels includes first and second pixels, the first pixels displaying a first displaying gray level indicated by the pseudo gray level data having the LSB of “1” in the second case, the second pixels displaying a second displaying gray level indicated by the pseudo gray level data having the LSB of “0” in the second case, and the pixel matrix unit includes a first area in which the first pixels are located and a second area in which the second pixels are located, it is desirable that the first and second area are alternately located in the pixel matrix unit.

It is also desirable that the pseudo gray level data generator defines the gray level data such that the pseudo gray level data equals upper m bits of the input gray level data in a third case when the carry bit is “1” and the input gray level belongs to second gray levels of the 2ⁿ gray levels other than the first gray levels, and such that upper m−1 bits of the pseudo gray level data equals upper m−1 bits of the input gray level data and the LSB of the pseudo gray level data is selected from “0” and “1” in a fourth case when the carry bit is “0” and the input gray level data belongs to the second gray levels.

In this case, it is desirable that upper m bits of the input gray level data are “1” and at least one of lower n−m bits of the input gray level data is “0” when the input gray level data represents any one of the second gray levels.

Furthermore, a third probability of the LSB of the pseudo gray level data being “0” in the fourth case is preferably substantially equal to a fourth probability of the LSB of the pseudo gray level data being “1” in the fourth case.

The pseudo gray level data generator preferably defines the pseudo gray level data such that the pseudo gray level data equals a sum of the carry bit and upper m bits of the input gray level data in a fifth case when the input gray level does not belong to any of the first and second gray levels.

The state variant data are preferably defined by

x(1)=x_{INI},

and

x(i)=u_{L}(i−1)+x(i−1) (i≧2),

where i is a natural number, u(i) is one of the input gray level data which is i-th inputted to the pseudo gray level data processor, and u_{L}(i) is lower n−m bits of u(i), x(i) is one of the state variant data which is produced in response to u(i), x_{INI} is a predetermined value.

In order to achieve another aspect of the present invention, a display apparatus is composed of a pseudo gray level data processor generating pseudo gray level data having m bits based on input gray level data having n bits representative of an input gray level of 2ⁿ gray levels, n being a natural number equal to or more than 2, and m being a natural number less than n. The pseudo gray level data processor includes a state variable generator, an adder, and a pseudo gray level generator. The state variable generator generates a state variable data having n−m bits, based on lower n−m bits of the input gray level data. The adder calculates a sum of the lower n−m bits of the input gray level data and the state variable data to output a carry bit representative of carry-over of the sum. The pseudo gray level data generator generates the pseudo gray level data based on the input gray level data and the carry bit. In a third case when the carry bit is “1” and the input gray level belongs to second gray levels of the 2ⁿ gray levels, the pseudo gray level data generator defines the pseudo gray level data such that the pseudo gray level data equals upper m bits of the input gray level data. In a fourth case when the carry bit is “0” and the input gray level data belongs to the second gray levels, the pseudo gray level data generator defines the pseudo gray level data such that upper m−1 bits of the pseudo gray level data equals upper m−1 bits of the input gray level data and the LSB (least significant bit) of the pseudo gray level data is selected from “0” and “1”.

In order to achieve still another aspect of the present invention, a display apparatus is composed of a pseudo gray level data processor generating pseudo gray level data having m bits based on input gray level data having n bits representative of an input gray level of 2ⁿ gray levels, n being a natural number equal to or more than 2, and m being a natural number less than n. The pseudo gray level data processor includes a state variable generator, a subtracter, and a pseudo gray level data generator. The state variable generator generates a state variable data having n−m bits, based on lower n−m bits of the input gray level data. The subtracter calculates the difference the lower n−m bits of the input gray level data minus and the state variable data to output a carry bit representative of carry-over of the difference. The pseudo gray level data generator generates the pseudo gray level data based on the input gray level data and the carry bit. In a first case when the carry bit is “0” and the input gray level belongs to first gray levels of the 2ⁿ gray levels, the pseudo gray level data generator defines the pseudo gray level data such that the pseudo gray level data equals upper m bits of the input gray level data. In a second case when the carry bit is “1” and the input gray level data belongs to the first gray levels, the pseudo gray level data generator defines the pseudo gray level data such that upper m−1 bits of the pseudo gray level data equals upper m−1 bits of the input gray level data and LSB (least significant bit) of the pseudo gray level data is selected from “0” and “1”.

It is desirable that the pseudo gray level data generator defines the gray level data such that the pseudo gray level data equals upper m bits of the input gray level data in a third case when the carry bit is “1” and the input gray level belongs to second gray levels of the 2ⁿ gray levels other than the first gray levels, and such that upper m−1 bits of the pseudo gray level data equals upper m−1 bits of the input gray level data and the LSB of the pseudo gray level data is selected from “0” and “1” in a fourth case when the carry bit is “0” and the input gray level data belongs to the second gray levels.

The pseudo gray level data generator preferably defines the pseudo gray level data such that the pseudo gray level data equals a difference upper m bits of the input gray level data minus the carry bit in a fifth case when the input gray level does not belong to any of the first and second gray levels.

The state variable data is preferably defined by

x(1)=x_{INI},

and

x(i)=u_{L}(i−1)−x(i−1) (i≧2)

where i is an natural number, u(i) is one of the input gray level data which is i-th inputted to the pseudo gray level data processor, and u_{L}(i) is lower n−m bits of u(i), x(i) is one of the state variant data which is produced in response to u(i), x_{INI} is a predetermined value.

In order to achieve still another aspect of the present invention, a display apparatus is composed of a pseudo gray level data processor generating pseudo gray level data having m bits based on input gray level data having n bits representative of an input gray level of 2ⁿ gray levels, n being a natural number equal to or more than 2, and m being a natural number less than n. The pseudo gray level data processor includes a state variable generator, a subtracter, and a pseudo gray level generator. The state variable generator generates a state variable data having n−m bits, based on lower n−m bits of the input gray level data. The subtracter calculates a difference the lower n−m bits of the input gray level data minus the state variable data to output a carry bit representative of carry-over of the difference. The pseudo gray level data generator generating the pseudo gray level data on the basis of the input gray level data and the carry bit. In a third case when the carry bit is “1” and the input gray level belongs to second gray levels of the 2ⁿ gray levels, the pseudo gray level data generator defines the pseudo gray level data such that the pseudo gray level data equals upper m bits of the input gray level data. In a fourth case when the carry bit is “0” and the input gray level data belongs to the second gray levels, the pseudo gray level data generator defines the pseudo gray level data such that upper m−1 bits of the pseudo gray level data equals upper m−1 bits of the input gray level data and LSB (least significant bit) of the pseudo gray level data is selected from “0” and “1”.

In order to achieve still another aspect of the present invention, a method of generating pseudo gray level data representative of pseudo gray level is composed of:

sequentially inputting input gray level data, each of which has n bits and is representative of an input gray level of 2ⁿ gray levels, n being a natural number equal to or more than 2, and

sequentially generating pseudo gray level data having m bits based on the input gray level data, m being a natural number less than n. The sequentially generating includes:

delaying work data having n−m bits by a duration substantially equal to a temporal interval at which the input gray level data is inputted to output state variable data,

calculating a sum of lower n−m bits of the input gray level data and the state variable data,

outputting the sum as the work data,

outputting a carry bit of the sum,

defining the pseudo gray level data such that the pseudo gray level data equals upper m bits of the input gray level data in a first case when the carry bit is “0” and the input gray level belongs to first gray levels of the 2ⁿ gray levels, and

defining the pseudo gray level data such that upper m−1 bits of the pseudo gray level data equals upper m−1 bits of the input gray level data and LSB of the pseudo gray level data is selected from “0” and “1” in a second case when the carry bit is “1” and the input gray level data belongs to the first gray levels.

In order to achieve still another aspect of the present invention, a method of generating pseudo gray level data representative of pseudo gray level is composed of:

sequentially inputting input gray level data, each of which has n bits and is representative of an input gray level of 2ⁿ gray levels, n being a natural number equal to or more than 2, and

sequentially generating pseudo gray level data having m bits based on the input gray level data, m being a natural number less than n. The sequentially generating includes:

delaying work data having n−m bits by a duration substantially equal to a temporal interval at which the input gray level data is inputted to output state variable data,

calculating a difference lower n−m bits of the input gray level data minus the state variable data,

outputting the difference as the work data,

outputting a carry bit of the difference,

defining the pseudo gray level data such that the pseudo gray level data equals upper m bits of the input gray level data in a first case when the carry bit is “0” and the input gray level belongs to first gray levels of the 2ⁿ gray levels, and

defining the pseudo gray level data such that upper m−1 bits of the pseudo gray level data equals upper m−1 bits of the input gray level data and LSB (least significant bit) of the pseudo gray level data is selected from “0” and “1” in a second case when the carry bit is “1” and the input gray level data belongs to the first gray levels.

### BRIEF DESCRIPTION OF THE DRAWINGS

FIG. 1 shows a conventional pseudo gray level processor;

FIG. 2 shows a configuration of a display apparatus of an embodiment of the present invention;

FIG. 3 shows order of frames;

FIG. 4 shows order of input gray level data uᵣ (i, j, k) inputted to the pseudo gray level processor 3;

FIG. 5 shows a configuration of pseudo gray level processors 3;

FIG. 6 shows a content of an initial value determination ROM 35a;

FIG. 7 shows an initial value Wᵣ^{INI};

FIG. 8 shows a correspondence between an input gray level data uᵣ and a pseudo gray level data yᵣ, in the first embodiment;

FIG. 9 shows a process for generating a pseudo gray level data y_{RA}, in Operation Example 1;

FIG. 10 shows a carry data CRYᵣ and a least significant bit (LSB) yᵣ^{LSB} in Operation Example 2;

FIG. 11 shows a process for generating a pseudo gray level data y_{RA}, in Operation Example 2;

FIG. 12 shows a carry data CRYᵣ and a LSB yᵣ^{LSB} in Operation Example 2;

FIG. 13 shows a method of defining an initial state variable data xᵣ^{INI};

FIG. 14 shows a line combination pattern;

FIG. 15 shows a frame combination pattern;

FIG. 16 shows pseudo gray level processors 3;

FIG. 17 shows a correspondence between an input gray level data uᵣ and a pseudo gray level data yᵣ in a second embodiment;

FIG. 18A shows a dependency of a transmissivity of pixels 8 on a voltage applied to the pixels 8;

FIG. 18B a dependency of a transmissivity of pixels 8 on a voltage applied to the pixels 8;

FIG. 19 shows a pseudo gray level processor 13 in a third embodiment;

FIG. 20 shows a correspondence between an input gray level data uᵣ and a pseudo gray level data yᵣ, in the third embodiment;

FIG. 21A shows zᵣ (j, k);

FIG. 21B shows zᵣ (j, k);

FIG. 22 shows a carry data CRYᵣ and a LSB yᵣ^{LSB}, in Operation Example 3;

FIG. 23 shows a carry data CRYᵣ and a LSB yᵣ^{LSB} in Operation Example 4;

FIG. 24 shows a pseudo gray level processor 13′; and

FIG. 25 shows a correspondence between an input gray level data uᵣ and a pseudo gray level data yᵣ, when the pseudo gray level processor 13′ is used.

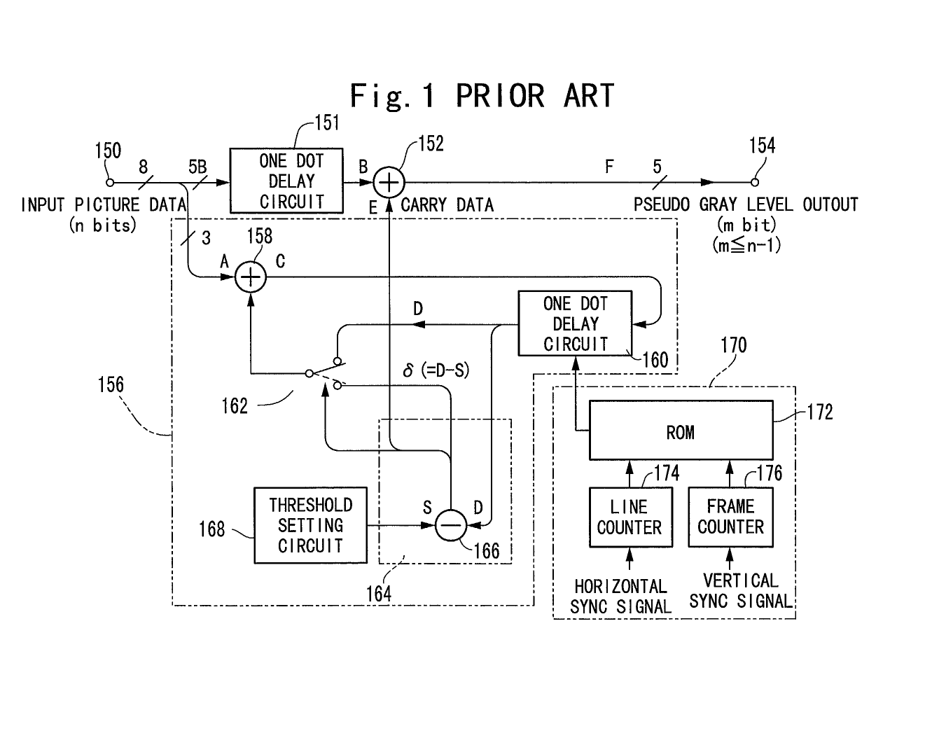

### DESCRIPTION OF THE PREFERRED EMBODIMENTS

A pseudo gray level processor and a display apparatus of an embodiment according to the present invention will be described below with reference to the attached drawings.

### First Embodiment

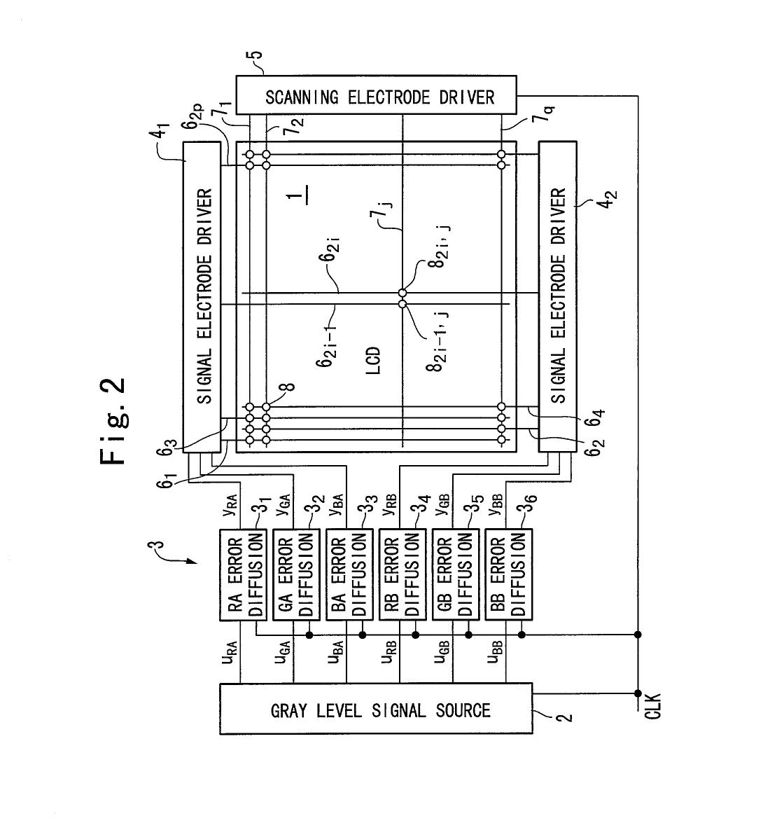

FIG. 2 shows a display apparatus of a first embodiment according to the present invention. The display apparatus is provided with an LCD 1, a gray level signal source 2, pseudo gray level processors 3₁-3₆, signal electrode drivers 4₁, 4₂ and a scanning electrode driving circuit 5. The pseudo gray level processors 3₁-3₆ may be referred to as pseudo gray level processors 3.

The LCD 1 displays 2p×q dots, where both of p and q are natural numbers. The LCD 1 has 2p longitudinal lines 6₁-6₂ₚ and q lateral lines 7₁-7_{q}. Each of the longitudinal lines 6₁-6₂ₚ includes an R signal line, a B signal line and a G signal line (not shown). Hereafter, in the specification, the longitudinal lines 6₁-6₂ₚ may be referred to as longitudinal lines 6, and the lateral lines 7₁ to 7_{q} may be totally to as lateral lines 7.

The LCD 1 has (2p×q) pixels 8. Each pixel 8 is connected to one of the longitudinal lines 6 and one of the lateral lines 7. Each of the pixels 8 is placed at a position at which longitudinal lines 6 and lateral lines 7 overlap. Hereinafter, a pixel placed at which a longitudinal line 6ₛ and a lateral line 7ₜ overlap is referred to as a pixel 8_{s, t}, in this specification where s is an integer between 1 and 2p, and t is an integer between 1 and q. The pixel 8_{s, t} connected to the lateral line 7ₜ is activated when the lateral line 7ₜ is selected by the scanning electrode driving circuit 5. When the pixel 8_{s, t} emits a light, a red brightness, a blue brightness and a green brightness there of are respectively determined by respective voltages of the R signal line, the B signal line and the G signal line contained in the longitudinal line 6ₛ connected to the pixel 8_{s, t}.

The gray level signal source 2 generates input gray level data u_{RA}, u_{GA}, u_{BA}, u_{RB}, u_{GB} and u_{BB}. All of the input gray level data u_{RA}, u_{GA}, u_{BA}, u_{RB}, u_{GB} and u_{BB} are n-bit data, and can represent 2ⁿ gray levels. In this embodiment, n is assumed to be 8.

The input gray level data u_{RA} specifies a gray level of red for a pixel 8₂ᵢ₋₁ connected to an odd-numbered longitudinal line 6₂ᵢ₋₁. Here, i is an integer between 1 and p. The input gray level data u_{GA} specifies a gray level of green for the pixel 8₂ᵢ₋₁ connected to the odd-numbered longitudinal line 6₂ᵢ₋₁. And, the input gray level data u_{BA} specifies a gray level of blue for the pixel 8₂ₗ₋₁ connected to the odd-numbered longitudinal line 6₂ₗ₋₁.

The input gray level data u_{RB} specifies a gray level of red for a pixel 8₂ᵢ connected to an even-numbered longitudinal line. The input gray level data u_{GA} specifies a gray level of green for the pixel 8₂ᵢ connected to the even-numbered longitudinal line 6₂ᵢ. And, the input gray level data u_{BA} specifies a gray level of blue for the pixel 8₂ᵢ connected to the even-numbered longitudinal line 6₂ᵢ.

Two input gray level data is provided for each of red, green and blue, and this facilitates faster responding of the LCD 1. The signal processing of input gray level data for one color is distributed to two of pseudo gray level processors 3 and reduces the required processing speed for the pseudo gray level processors 3.

All of the input gray level data u_{RA}, u_{GA}, u_{BA}, u_{RB}, u_{GB} and u_{BB} are inputted to the pseudo gray level processors 3 in synchronous with a clock signal CLK. The gray level signal source 2 generates the input gray level data u_{RA}, u_{GA}, u_{BA} representative of one gray level of the pixel 8 for each clock cycle of the clock signal CLK. In the same way, the gray level signal source 2 generates the input gray level data u_{RB}, u_{GB}, u_{BB} indicative of the other gray level of the pixel 8 for each clock cycle of the clock signal CLK.

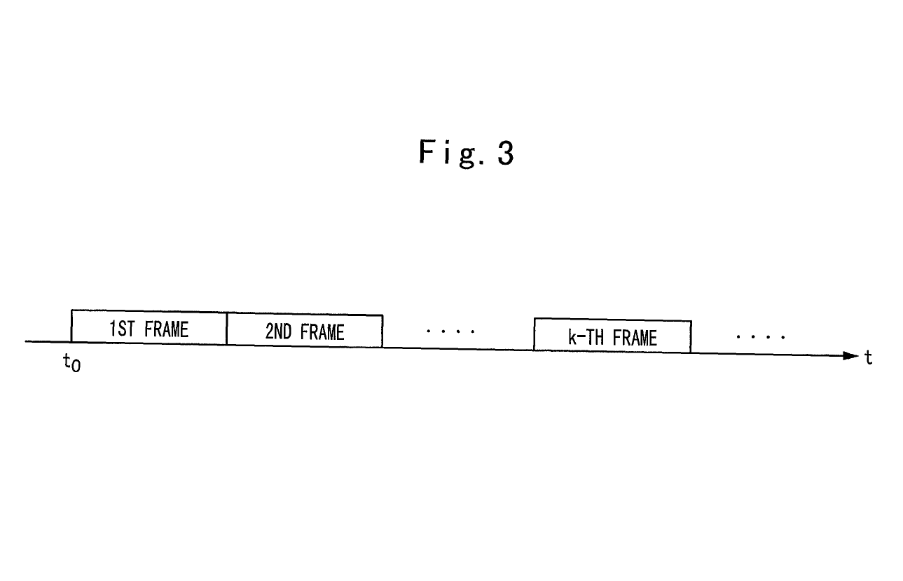

The input gray level data u_{RA} is generated as follows. A period while the LCD 1 displays a picture is divided into n frames as shown in FIG. 3. Each of the pixels 8 is turned on once a frame. In the following explanation, an element of the input gray level data u_{RA} which is representative of a gray level in the k-th frame of a pixel 8_{2i-1, j} is referred to as an input gray level data u_{RA} (i, j, k).

The input gray level data u_{RA} (i, j, k) are generated in the ascending order of the affix k. In the same frame, that is, for the same k, the input gray level data u_{RA} (i, j, k) are generated in the ascending order of the affix j. Moreover, In the same lateral line, that is, for the same j, the input gray level data u_{RA} (i, j, k) are generated in the ascending order of the affix i.

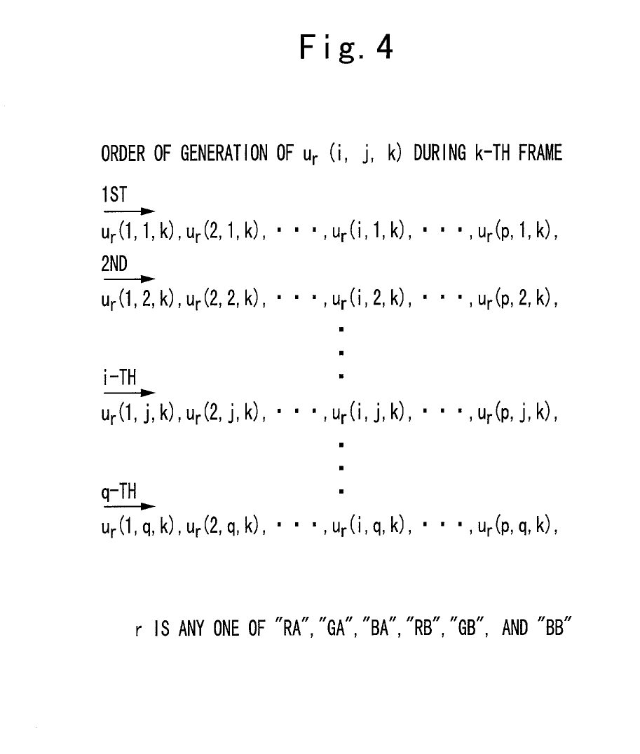

That is, as shown in FIG. 4, the input gray level data u_{RA} (i, 1, 1) representative of gray levels of the pixels 8_{2i-1, 1} in a first frame are inputted in the ascending order of i. After the input of the input gray level data u_{RA} (i, 1, 1), the input gray level data u_{RA} (i, 2, 1) representative of gray levels of the pixels 8_{i, 2} are inputted. Hereafter, similarly, the input gray level data u_{RA} (i, j, 1) representative of gray levels of pixels 8_{2l-1, j} are inputted in turn. After the input gray level data u_{RA} (i, j, 1), which are representative of the gray levels in all the pixels 8 in the first frame, other input gray level data u_{RA} (i, j, k) representative of gray levels of a pixel 8_{2l-1, j} in the successive frames are generated in turn.

Other input gray level data u_{GA} and u_{BA} are also generated in the same way as the input gray level data u_{RA}.

Also, an element of the input gray level data u_{RB} which is representative of a gray level in a k-th frame of a pixel 8_{2i, j} is hereafter referred to as an input gray level data u_{RB} (i, j, k). The input gray level data u_{RB} (i, j, k) is generated in the same order as the input gray level data u_{RB} (i, j, k). That is, the input gray level data u_{RB} (i, j, k) are generated in the ascending order of the affix k. For the same affix k, the input gray level data u_{RB} (i, j, k) are generated in the ascending order of the affix k. For the same affixes j and k, the input gray level data u_{RB} (i, j, k) are generated in the ascending order of the affix i.

Other input gray level data u_{GB} and u_{BB} are also generated in the same way as the input gray level data u_{RB}.

The generated input gray level data u_{RA}, u_{GA}, u_{BA}, u_{RB}, u_{GB} and u_{BB} are inputted to the pseudo gray level processors 3₁-3₆ in the generated order, respectively.

The pseudo gray level processor 3₁ generates a pseudo gray level data y_{RA} that is an m-bit data, from an input gray level data u_{RA}, which is an n-bit data. Similarly, the pseudo gray level processors 3₂, 3₃, 3₄, 3₅ and 3₆ generate pseudo gray level data y_{GA}, y_{BA}, y_{RB}, y_{GB} and y_{BB} that are respectively m-bit data, from input gray level data u_{GA}, u_{BA}, u_{RB}, u_{GB} and u_{BB} that are respectively n-bit data. In this embodiment, m is assumed to be 2. All of the pseudo gray level data y_{RA}, y_{GA}, y_{BA}, y_{RB}, y_{GB} and y_{BB} are generated synchronously with the clock signal CLK. The pseudo gray level data y_{RA}, y_{GA}, y_{BA}, y_{RB}, y_{GB} and y_{BB} respective of one gray level in the pixels 8 are generated for each clock cycle of the clock signal CLK.

Among the pseudo gray level data y_{RA}, y_{GA} and y_{BA}, elements representative of gray levels in k-th frame of the pixel 8_{2i-1, j} are hereafter referred to as pseudo gray level data y_{RA} (i, j, k), y_{GA} (i, j, k) and y_{BA} (i, j, k), respectively.

Similarly, elements of pseudo gray level data y_{RB}, y_{GB} and y_{BB} which are representative of gray levels in k-th frame of the pixel 8_{2l, j} are hereafter referred to as pseudo gray level data y_{RB} (i, j, k), y_{GB} (i, j, k) and y_{BB} (i, j , k) respectively.

The pseudo gray level data y_{RA}, y_{GA} and y_{BA} are inputted to the signal electrode driver 4₁, as shown in FIG. 2.

The signal electrode driver 4₁ determines the voltages of the R signal line, the G signal line and the B signal line contained in the odd-numbered longitudinal lines 6 from the left side, on the basis of the pseudo gray level data y_{RA}, y_{GA} and y_{BA}. The voltage of the R signal line of the longitudinal line 6₂ᵢ₋₁ is determined on the basis of the pseudo gray level data y_{RA}. The voltage of the G signal line of the longitudinal line 6₂ᵢ₋₁ is determined on the basis of the pseudo gray level data y_{GA}. The voltage of the B signal line of the longitudinal line 6₂ᵢ₋₁ is determined on the basis of the pseudo gray level data y_{BA}.

Also, the pseudo gray level data y_{RB}, y_{GB} and y_{BB} generated by the pseudo gray level processors 3₄-3₆ are inputted to the signal electrode driver 4₂.

The signal electrode driver 4₂ determines the voltages of the R signal line, the G signal line and the B signal line contained in the even-numbered longitudinal lines 6₂ᵢ from the left side, on the basis of the pseudo gray level data y_{RB}, y_{GB} and y_{BB}. The voltage of the R signal line of the longitudinal line 6₂ₗ is determined on the basis of the pseudo gray level data y_{RB}. The voltage of the G signal line of the longitudinal line 6₂ₗ is determined on the basis of the pseudo gray level data y_{GB}. The voltage of the B signal line of the longitudinal line 6₂ᵢ is determined on the basis of the pseudo gray level data y_{BB}.

The scanning electrode driving circuit 5 enables any of the longitudinal lines 7₁-7ₚ in synchronization with the clock signal CLK. The enable operation of the longitudinal lines 7₁-7ₚ is synchronous with the pseudo gray level data y_{RA}, y_{GA}, y_{BA}, y_{RB}, y_{GB} and y_{BB}. That is, the longitudinal line 7ⱼ is enabled while the pseudo gray level data y_{RA} (i, j, k), y_{GA} (i, j, k), y_{BA} (i, j, k), y_{RB} (i, j, k), y_{GB} (i, j, k) and y_{BB} (i, j, k) representative of the gray levels of the pixels 8_{2i-1, j} and 8₂ₗ, ⱼ are outputted by the pseudo gray level processors 3₁ to 3₆, and the pixel pixels 8_{2i-1, j} and 8₂ᵢ, ⱼ display the gray level indicated by the pseudo gray level data.

In the display apparatus, the pseudo gray level processors 3₁-3₆ generate the pseudo gray level data y_{RA}, y_{GA}, y_{BA}, y_{RB}, y_{GB} and y_{BB} that are the m-bit data, respectively, from the input gray level data u_{RA}, u_{GA}, u_{BA}, u_{RB}, u_{GB}, u_{BB} that are the n-bit data. The configuration and the operation of the pseudo gray level processors 3₁-3₆ described below allows the pseudo gray level data y_{RA}, y_{GA}, y_{BA}, y_{RB}, y_{GB} and y_{BB} to be representative of all the 2ⁿ gray levels.

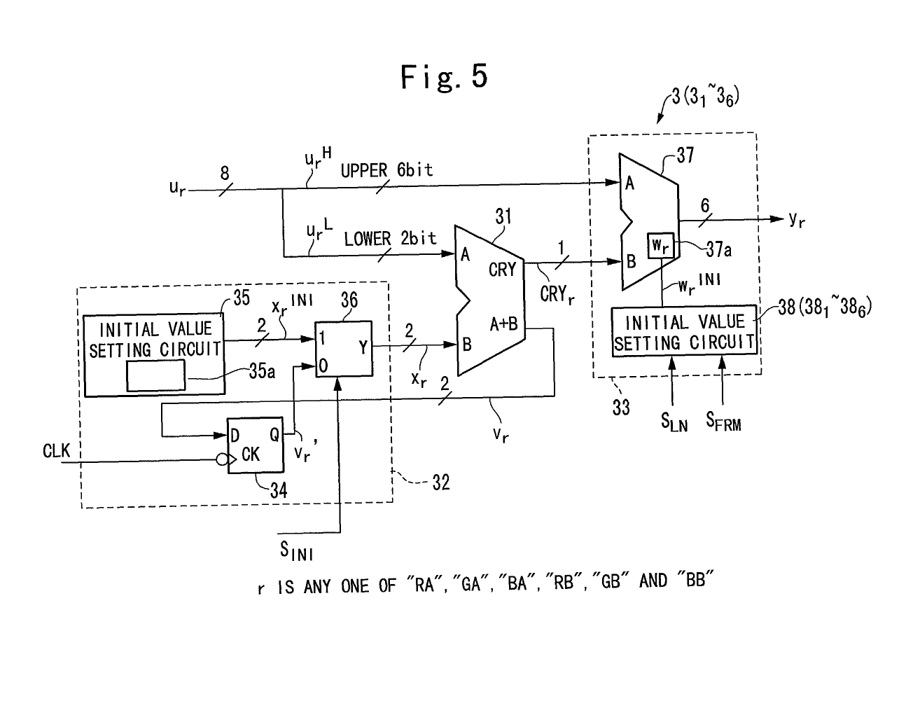

The pseudo gray level processors 3 implement an improved error diffusion method for generating pseudo gray level data. FIG. 5 shows the configuration of the pseudo gray level processors 3. In FIG. 5 and the following, r is an affix implying any of “RA”, “GA”, “BA”, “RB”, “GB” and “BB”. For r being “RA”, FIG. 5 shows the configuration of the pseudo gray level processor 3₁. Similarly, For r being “GA”, “BA”, “RB”, “GB” or “BB”, FIG. 5 shows the configuration of the pseudo gray level processor 3₂, 3₃, 3₄, 3₅, or 3₆, respectively.

Each of the pseudo gray level processors 3₁-3₆ includes an adder 31, a state variable data generator 32 and a pseudo gray level data calculator 33.

The adder 31 receives an (n−m)-bit state variable data xᵣ (i, j, k) generated by the state variable data generator 32 and a lower bit data uᵣ^{L} (i, j, k) which is the lower n−m bits of the input gray level data uᵣ (i, j, k). Here, the state variable data xᵣ (i, j, k) is generated correspondingly to the input gray level data uᵣ (i, j, k). The adder 31 adds the state variable data xᵣ (i, j, k) and the lower bit data uᵣ^{L} (i, j, k) to generate an (n−m)-bit value vᵣ (i, j, k).

That is, the value vᵣ (i, j, k) is given by

vᵣ(i, j, k)=xᵣ(i, j, k)+uᵣ^{L}(i, j, k).

The value vᵣ (i, j, k) is inputted to the state variable data generator 32.

The state variable data generator 32 includes a D-flip-flop 34, an initial value setting circuit 35 and a switch 36. The D-flip-flop 34 delays the value vᵣ (i, j, k) by one clock cycle in synchronization with the clock signal CLK to output a value data vᵣ′ (i, j, k), namely,

vᵣ′ (i, j, k)=vᵣ (i−1, j, k).

The initial value setting circuit 35 defines an initial state variable data xᵣ^{INI}. The initial state variable data xᵣ^{INI} is defined independently for each of the lateral lines 7, and independently defined for each frame. In the initial state variable data xᵣ^{INI}, an element-defined for the lateral line 7ⱼ of the k-th frame is referred to as an initial state variable data xᵣ^{INI} (j, k). Also, the initial state variable data xᵣ^{INI} is independently defined for each of the pseudo gray level processors 3₁-3₆. That is, the initial value setting circuits 35₁-35₆ define the initial state variable data xᵣ^{INI} independently of each other, where the initial value setting circuits 35 included in the pseudo gray level processors 3₁-3₆ are referred to as initial value setting circuits 35₁-35₆, respectively.

Each of the initial value setting circuit 35 includes initial value determining ROMs 35a for defining the initial state variable data xᵣ^{INI} (j, k). In the initial value determiner ROMs 35a, respective elements included by the initial value setting circuits 35₁-35₆ are referred to as initial value determiner ROMs 35a₁ to 35a₆, respectively.

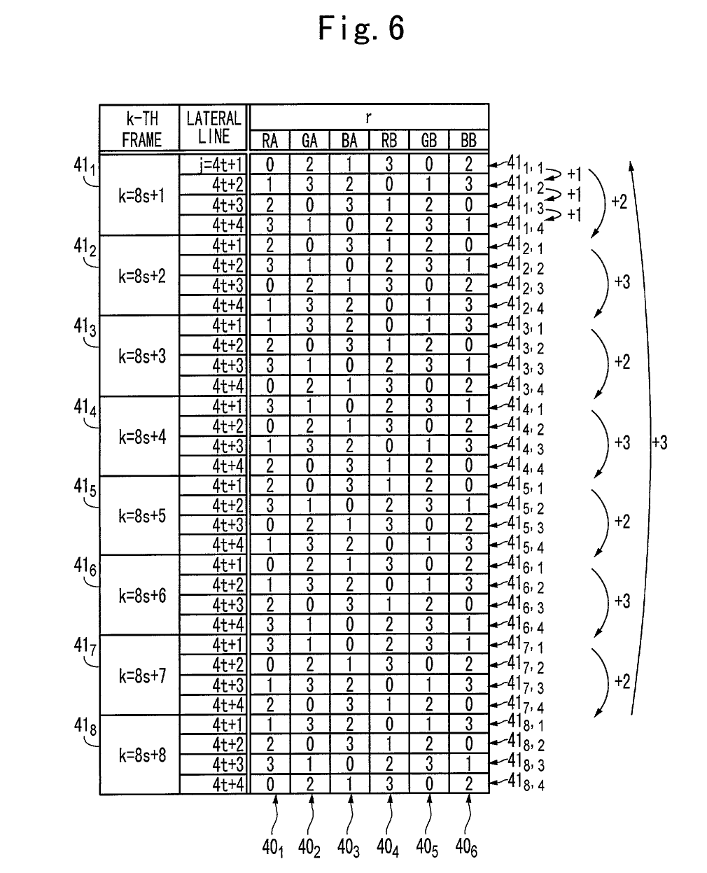

FIG. 6 is a table illustrating the contents of the initial value determiner ROMs 35a₁ to 35a₆. A value “0” illustrated in the table of FIG. 6 implies that the initial state variable data xᵣ^{INI} is “00”. Similarly, values “1”, “2” and “3” imply that the initial state variable data xᵣ^{INI} are “01”, “10” and “11”, respectively.

Columns 40₁-40₆ included in the table of FIG. 6 indicate the values of the initial state variable data xᵣ^{INI} (j, k) defined when r is “RA”, “GA”, “BA”, “RB”, “GB” and “BB”, respectively. That is, the columns 40₁-40₆ indicate the contents of the initial value determiner ROMs 35a₁ to 35a₆, respectively.

The table shown in FIG. 6 includes rows 41₁-41₈. The row 41₁ includes rows 41_{1, 1}-41_{1, 4}. Similarly, the line 41_{α} includes rows 41_{α, 1}-41_{α, 4}, where α is a natural number equal to or less than 8. The row 41_{α, β} indicates an initial state variable data xᵣ^{INI} defined for the lateral line 7ⱼ, which is j=4t+β of the k-th frame of k=8s+α. Here, s and t are integers equal to or greater than 0.

For example, let us consider an initial state variable data x_{RA}^{INI} (1, 1) in a case when j=k=1. The initial state variable data x_{RA}^{INI} (1, 1) is the initial state variable data x_{RA}^{INI} (1, 1) defined for a lateral line 7₁ during the first frame. With reference to FIG. 6, the initial state variable data x_{RA}^{INI} (1, 1) is set to “0” that is a value indicated for a column 40₁ and a row 41_{1, 1}. For the other r, j and k, the initial value setting circuits 35₁-35₆ refer to the initial value determiner ROMs 35a₁-35a₆, respectively, and define the initial state variable data x_{RA}^{INI} (j, k), x_{GA}^{INI} (j, k), x_{BA}^{INI} (j, k), x_{RB}^{INI} (j, k), x_{GB}^{INI} (j, k), x_{BB}^{INI} (j, k), respectively. The method of determining the content of the initial value determiner ROM 35a will be described later in detail.

The switch 36 is responsive to an initial value data switching signal S_{INI} for outputting the initial state variable data xᵣ^{INI} or the value vᵣ′ as the above-mentioned state variable data xᵣ as shown in FIG. 5. The initial value data switching signal S_{INI} is set to “1”, when an input gray level data uᵣ representative of gray levels of a pixel 8_{1, t} and a pixel 8_{2, t} connected to two longitudinal lines 6₁, 6₂ located on a leftmost side is inputted, namely, in a case when i=1. The initial value data switching signal S_{INI} is set to “0”, when an input gray level data uᵣ indicative of a gray level of a pixel 8 connected to another longitudinal line 6 is inputted, namely, in a case when i≧2.

The switch 36 outputs the initial state variable data xᵣ^{INI} as the state variable data xᵣ, when the initial value data switching signal S_{INI} is at “1”, namely, in a case when i=1. The switch 36 outputs the value vᵣ′ as the state variable data xᵣ, when the initial value data switching signal S_{INI} is at “0”, namely, in a case of i≧2.

The state variable data xᵣ is represented in the case when i=1, by

xᵣ (i, j, k)=xᵣ^{INI}(j, k),

and is represented in the case when i≧2 by

$${x}_{r} ( i , j , k ) = {v}_{r}^{′} ( i , j , k ) , \\ = {x}_{r} ( i - 1 , j , k ) , \\ = {x}_{r} ( i - 1 , j , k ) + {u}_{r}^{L} ( i - 1 , j , k ) .$$

The state variable data generator 32 outputs the state variable data xᵣ (i, j, k) to the adder 31.

As mentioned above, the adder 31 outputs the sum of the state variable data xᵣ (i, j, k) and the lower bit data uᵣ (i, j, k) as the value vᵣ (i, j, k).

In addition, the adder 31 outputs one-bit carry data CRYᵣ (i, j, k), on the basis of the sum of the state variable data xᵣ (i, j, k) and the lower bit data uᵣ^{L} (i, j, k). If the sum of the state variable data xᵣ (i, j, k) and the lower bit data uᵣ^{L} (i, j, k) is a number that can not be represented by the n−m bits, namely, if a carry-over is induced, the adder 31 sets the carry data CRYᵣ (i, j, k) to “1” and outputs the carry data CRYᵣ (i, j, k) to the pseudo gray level data calculator 33. On the other hand, when the carry-over is not induced, the adder 31 sets the carry data CRYᵣ (i, j, k) to “0” to output to the pseudo gray level data calculator 33.

As mentioned above, the calculation for calculating the carry data CRYᵣ (i, j, k) from the lower bit data uᵣ^{L} (i, j, k) is generally referred to as a primary error diffusion calculation. The carry data CRYᵣ (i, j, k) is inputted to the pseudo gray level data calculator 33.

The pseudo gray level data calculator 33 includes a calculator 37 and an initial value setting circuit 38. The calculator 37 includes a one-bit counter 37a storing a one-bit value Wᵣ, which is any one of “1” and “0”.

The initial value setting circuit 38 sets the value Wᵣ storing in the counter 37a to an initial value Wᵣ^{INI}, for each input of the input gray level data uᵣ (i, j, k) indicating the gray levels of the pixel 8_{i, j} and the pixel 8_{2, j}, which are located on the left of the LCD 1. That is, the initial value setting circuit 38 sets the initial value Wᵣ^{INI} for each lateral line 7 and for each frame. The initial value setting circuit 38 recognizes for which frame and lateral line the inputted input gray level data uᵣ indicating the gray level of the pixel 8 is inputted, on the basis of a line management signal S_{LN} and a frame management signal S_{FRM}. That is, the initial value setting circuit 38 recognizes the affixes j and k on the basis of the line management signal S_{LN} and the frame management signal S_{FRM}, and defines the initial value Wᵣ^{INI} on the basis of the affixes j, and k. Hereafter, in the initial value Wᵣ^{INI}, an element defined for a lateral line 7ⱼ in a k-th frame is referred to as an initial value Wᵣ^{INI} (j, k).

In addition, the initial value setting circuit 38 defines the initial value Wᵣ^{INI} independently for each of the pseudo gray level processors 3₁-3₆. That is, the initial value setting circuits 38₁-38₆ define the initial values Wᵣ^{INI}, independently of each other, where the initial value setting circuits 38 respectively included in the pseudo gray level processors 3₁-3₆ are referred to as the initial value setting circuits 38₁-38₆, respectively.

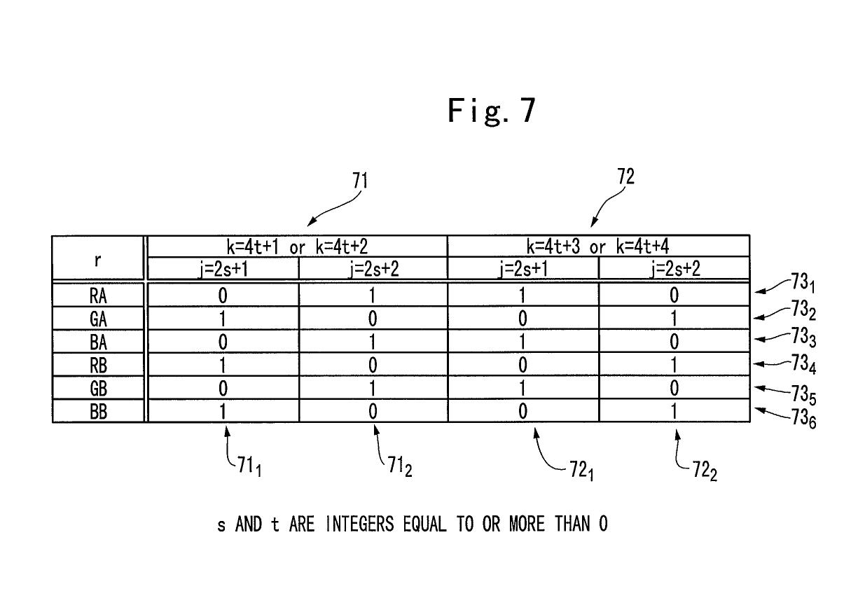

A table of FIG. 7 shows the correspondence between r, j, k and the initial value Wᵣ^{INI} (j, k). A column 71 indicates the initial value Wᵣ^{INI} (j, k) in a case when k=4t+1, or 4t+2 (t is an integer of 0 or more). A column 72 indicates an initial value Wᵣ^{INI} (j, k) in a case when k=4t+3, or 4t+4. The column 71 includes a column 71₁ and a column 71₂. The column 72 includes a column 72₁ and a column 72₂. The column 71₁ and the column 72₁ show the initial value Wᵣ^{INI} (j, k) in a case when j=2s+1 (s is an integer of 0 or more). The column 71₂ and the column 72₂ show the initial value Wᵣ^{INI} (j, k) in a case of j=2s+2 (s is an integer of 0 or more). On the other hand, rows 73₁-73₆ indicate the initial values Wᵣ^{INI} (j, k) in the cases when r=“RA”, “RB”, “BA”, “RB”, “GB” and “BB”, respectively. For example, the initial value Wᵣ^{INI} (1, 1), which is defined for the lateral line 7ⱼ of the first frame, is at “0” as shown in the column 71₁ and the row 73₁.

The calculator 37 generates a pseudo gray level data yᵣ (i, j, k) on the basis of the input gray level data uᵣ (i, j, k), the carry data CRYᵣ (i, j, k) and the value Wᵣ stored in the counter 37a, as shown in FIG. 5.

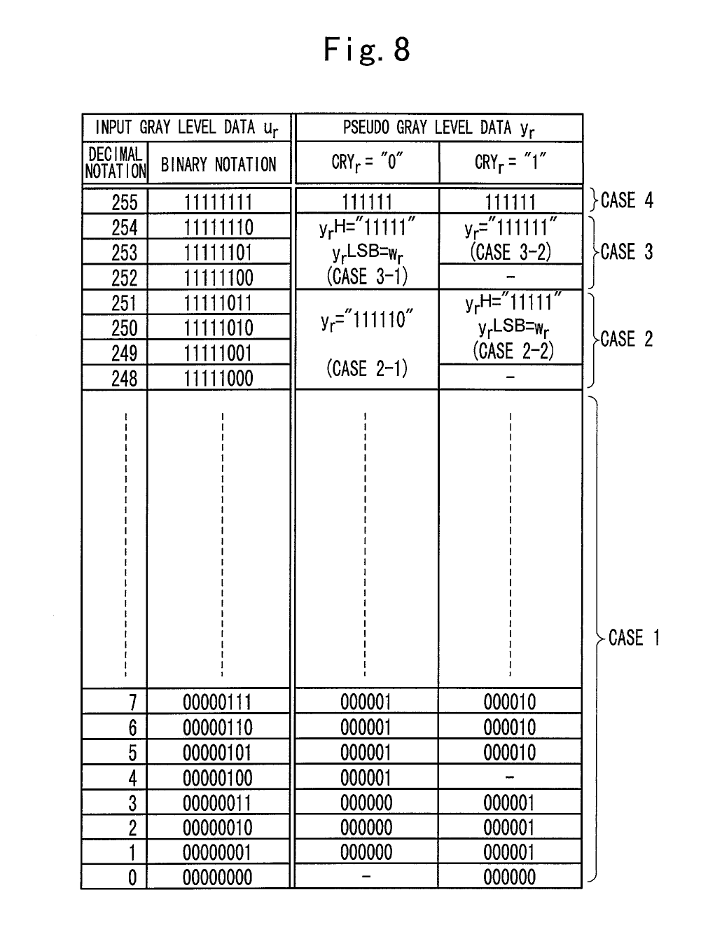

FIG. 8 is a truth table of the pseudo gray level data yᵣ (i, j, k) outputted by the calculator 37. Different calculations are carried out by the calculator 37 for Case 1-4 as described in the following.

Case 1

Case 1 is the case when at least one of the upper order (m−1) bits of the input gray level data uᵣ (i, j, k) is at “0”, that is, the case when uᵣ (i, j, k) in the decimal notation is given by

0≦uᵣ (i, j, k)≦2ⁿ−2^{(n-m+1)}−1.

In this embodiment of n=8 and m=6, Case 1 is the case when

0≦uᵣ (i, j, k)≦247.

In Case 1, the pseudo gray level data yᵣ (i, j, k) is defined by:

yᵣ (i, j, k)=uᵣ^{H1} (i, j, k)+CRYᵣ (i, j, k),

where uᵣ^{H1} (i, j, k) is upper m Bit of the input gray level data uᵣ (i, j, k).

Case 2

Case 2 is the case when all of the upper (m−1) bits of the input gray level data uᵣ (i, j, k) are at “1” and an m-th significant bit of the input gray level data uᵣ (i, j, k) is at “0”. In the embodiment of n=8 and m=6, Case 2 is the case when

uᵣ^{H1} (i, j, k)=“111110”.

For the input gray level data uᵣ (i, j, k) in the decimal notation, Case 2 is the case

2ⁿ−2^{(n-m+1)}≦uᵣ (i, j, k)≦2ⁿ−2^{(n-m)}−1,

In this embodiment of n=8 and m=6, it holds

248≦uᵣ (i, j, k)≦251.

Case 2 is further classified into the following two cases, depending on the carry data CRYᵣ (i, j, k).

Case 2-1

Case 2-1 is the case when the carry data CRYᵣ (i, j, k)=“0”. In Case 2-1, the pseudo gray level data yᵣ (i, j, k) is defined by

yᵣ (i, j, k)=uᵣ^{H1} (i, j, k),

where uᵣ^{H1} (i, j, k) is the upper m bits of the input gray level data uᵣ (i, j, k), as mentioned above. In this embodiment, pseudo gray level data yᵣ (i, j, k) is defined by

yᵣ (i, j, k)=“111110”,

in Case 2-1.

Case 2-2

Case 2-2 is the case when the carry data CRYᵣ (i, j, k)=“1”. In Case 2-2, the upper bit data yᵣ^{H} (i, j, k) that is the upper (m−1) bits of the pseudo gray level data yᵣ (i, j, k) is given by

yᵣ^{H} (i, j, k)=uᵣ^{H2} (i, j, k),

where uᵣ^{H2} (i, j, k) is the upper (m−1) bits of the input gray level data uᵣ (i, j, k).

On the other hand, the LSB yᵣ^{LSB} (i, j, k) of the pseudo gray level data yᵣ (i, j, k) is defined by:

yᵣ^{LSB} (i, j, k)=Wᵣ,

where Wᵣ is the value stored in the counter 37a as mentioned above. The value Wᵣ is toggled each time the LSB yᵣ^{LSB} (i, j, k) is generated on the basis of the value Wᵣ. That is, when “0” is stored as the value Wᵣ and the LSB yᵣ^{LSB} (i, j, k) is generated on the basis of the value Wᵣ, the stored value Wᵣ is then inverted to “1”. Similarly, when “1” is held as the value Wᵣ and the LSB yᵣ^{LSB} (i, j, k) is generated on the basis of the value Wᵣ, the value Wᵣ is then inverted to “0”.

When all the bits of the lower bit data uᵣ^{L} (i, j, k) which is the lower (n−m) bits of the input gray level data uᵣ (i, j, k) are at “0”, the carry-over is never induced by the adding of the lower bit data uᵣ^{L} (i, j, k) and the state variable data xᵣ (i, j, k). In this embodiment of n=8 and m=6, it corresponds to the case when

uᵣ (i, j, k)=“11111000”.

In FIG. 8, the fact that the carry-over is never induced is indicated by a symbol “−”.

Case 3

Case 3 is the case when all of the upper m bits of the input gray level data uᵣ (i, j, k) are at “1” and at least one of the lower (n−m) bits of the input gray level data uᵣ (i, j, k) is at “0”. In the embodiment of n=8 and m=6, Case 3 implies the case when

uᵣ^{H1} (i, j, k)=“111111”,

and

uᵣ (i, j, k)≠“11111111”.

For the input gray level data uᵣ (i, j, k) in the decimal notation, Case 3 is the case when

2ⁿ−2^{(n-m)}≦uᵣ (i, j, k)≦2ⁿ−2.

In the embodiment of n=8 and m=6, it holds

252≦uᵣ (i, j, k)≦254.

Case 2 is further classified into the following two cases, depending on the carry data CRYᵣ (i, j, k).

Case 3-1

Case 3-1 is the case when the carry data CRYᵣ (i, j, k) is “0”. In Case 3-1, the upper bit data yᵣ^{H} (i, j, k), which is the upper (m−1) bits of the pseudo gray level data yᵣ (i, j, k) is given by

yᵣ^{H} (i, j, k)=uᵣ^{H2} (i , j, k),

where, uᵣ^{H2} (i, j, k) is the upper (m−1) bits of the input gray level data uᵣ (i, j, k).

On the other hand, the LSB yᵣ^{LSB} (i, j, k) of the pseudo gray level data yᵣ (i, j, k) is given by

yᵣ^{LSB} (i, j, k)=Wᵣ.

where Wᵣ is the value stored in the counter 37a. The value Wᵣ is toggled each time the least significant bit data yᵣ^{LSB} (i, j, k) is generated on the basis of the stored value Wᵣ. Thus, the LSB yᵣ^{LSB} (i, j, k) becomes at “0” at the rate of once every two times, and becomes at “1” at the rate of once every two times.

Case 3-2

Case 3-2 is the case when the carry data CRYᵣ (i, j, k)=“1”. In Case 3-2, the pseudo gray level data yᵣ (i, j, k) is defined by

yᵣ (i, j, k)=uᵣ^{H1} (i, j, k),

where uᵣ^{H1} (i, j, k) is the upper m bits of the input gray level data uᵣ (i, j, k), as mentioned above. In this embodiment, the pseudo gray level data yᵣ is given by:

yᵣ (i, j, k)=“111111”

When all the bits of the lower bit data uᵣ^{L} (i, j, k) are at “0”, the carry-over is never induced by the adding of the lower bit data uᵣ^{L} (i, j, k) and the state variable data xᵣ (i, j, k). In this embodiment of n=8 and m=6, it corresponds to the case when

uᵣ (i, j, k)=“11111100”

In FIG. 8, the fact that the carry-over is never induced in the case of uᵣ (i, j, k)=“11111100” is indicated by the symbol “−”.

Case 4

Case 4 is the case when all of the bits of the input gray level data uᵣ (i, j, k) are at “1”. In the embodiment of n=8 and m=6, Case 4 is the case when

uᵣ (i, j, k)=“11111111”.

For the input gray level data uᵣ (i, j, k) in the decimal notation, Case 4 is the case when

uᵣ (i, j, k)=2ⁿ−1.

In Case 4, the pseudo gray level data yᵣ is defined by

yᵣ (i, j, k)=uᵣ^{H1} (i, j, k),

where uᵣ^{H1} (i, j, k) is the upper m bits of the input gray level data uᵣ (i, j, k). That is, in this embodiment, the pseudo gray level data yᵣ is given by

yᵣ (i, j, k)=“111111”.

The m-bit pseudo gray level data yᵣ (i, j, k) generated by the pseudo gray level data calculator 33 can represent the 2ⁿ gray levels. If the same process as the case 1 is performed for all of Case 1-4, that is, if the pseudo gray level data yᵣ (i, j, k) is defined by

yᵣ (i, j, k)=uᵣ^{H1} (i, j, k)+CRYᵣ (i, j, k),

it is impossible to indicate the 2ⁿ gray levels by the pseudo gray level data yᵣ (i, j, k). The above-mentioned conventional pseudo gray level processor, disclosed by Matsunaga et al. in Japanese Laid Open Patent Application, (JP-A-Heisei, 9-90902), allows to display only the 253 gray levels although the pseudo gray level processor is provided with gray level data representative of the 256 gray levels in the case when n=8 and m=6. The employment of the pseudo gray level processor according to the present invention enables the representation of the 256 gray levels.

Examples of the process for generating the pseudo gray level data yᵣ (i, j, k) will be described below with regard to the input gray level data uᵣ (i, j, k) being an actual value.

### Operation Example 1

In Example 1, a process for generating the pseudo gray level data yᵣ (i, j, k) is described for the case when the input gray level data uᵣ (i, j, k) is given by

uᵣ (i, j, k)=“11111001”,

that is,

uᵣ (i, j, k)=249.

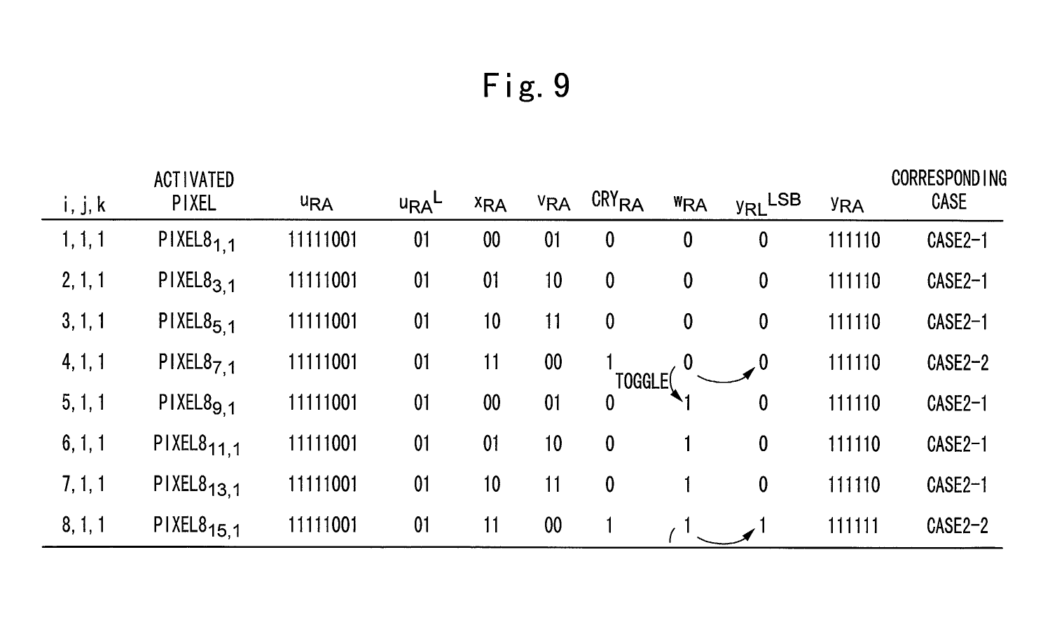

This is Case 2 as mentioned above. Also, it is assumed that r is “RA”, that is, the process for generating a pseudo gray level data y_{RA} (i, j, k) will be described in the following. FIG. 9 shows the state variable data x_{RA}, the value v_{RA}, the carry data CRY_{RA}, the value W_{RA}, the pseudo gray level data y_{RA} to be finally generated, and its least significant bit y_{RA}^{LSB}. FIG. 9 shows x_{RA}, v_{RA}, CRY_{RA}, W_{RA}, y_{RA} and y_{RA}^{LSB} for i being an integer between 1 and 8. The operation of the pseudo gray level processors 3 will be described below with reference to FIG. 9.

Pixel 8_{1, 1} During the First Frame (i=j=k=1)

At first, the initial state variable data x_{RA}^{INI} (1, 1) and the initial value W_{RA}^{INI} (1, 1) are defined. With reference to FIG. 6, the initial state variable data x_{RA}^{INI} (1, 1) is given by

x_{RA}^{INI} (1, 1)=“00”.

Also, with reference to FIG. 7, the initial value W_{RA}^{INI} (1, 1) is given by:

W_{RA}^{INI} (1, 1)=“0”.

The value W_{RA}, which is stored in the counter 37a, is defined by

W_{RA}=“0”.

The pseudo gray level data y_{RA} (1, 1, 1) is defined as follows.

The input gray level data u_{RA} (1, 1, 1), which is “11111001”, is inputted to the pseudo gray level processor 3₁. Since i=1, the state variable data x_{RA} (1, 1, 1) is defined as being the initial state variable data x_{RA}^{INI} (1, 1) generated by the initial value setting circuit 35. That is, the state variable data x_{RA} (1, 1, 1) is given by

x_{RA} (1, 1, 1)=x_{RA}^{INI} (1, 1).

That is, as shown in FIG. 9,

x_{RA} (1, 1, 1)=“00”.

A lower bit data u_{RA}^{L} (1, 1, 1), which is lower two bits of the input gray level data u_{RA}^{L} (1, 1, 1), is given by

u_{RA}^{L} (1, 1, 1)=“01”.

As shown in FIG. 9, The carry data CRY_{RA} (1, 1, 1), which is a carry-over bit (carry bit) of the sum of the lower bit data u_{RA}^{L} (1, 1, 1) and the state variable data x_{RA} (1, 1, 1), is given by

CRY_{RA} (1, 1, 1)=“0”.

The pseudo gray level data y_{RA} (1, 1, 1) is defined in accordance with Case 2-1. That is, The pseudo gray level data y_{RA} (1, 1, 1) is given by

y_{RA} (1, 1, 1)=“111110”.

As shown in FIG. 9, the least significant bit y_{RA}^{LSB} (1, 1, 1) is given by

y_{RA}^{LSB} (1, 1, 1)=“0”.

In the meantime, the value v_{RA} (1, 1, 1), which is the sum of the lower bit data u_{RA}^{L} (1, 1, 1) and the state variable data x_{RA} (1, 1, 1), is given by

$${v}_{RA} ( 1 , 1 , 1 ) = {x}_{RA} ( 1 , 1 , 1 ) + {u}_{RA}^{L} ( 1 , 1 , 1 ) \\ = '' 01 '' .$$

Also, the value W_{RA} is maintained in the original state. That is, for i being 2, the value W_{RA} is given by

W_{RA}=“0”.

Pixel 8_{3, 1} During the First Frame (i=2, j=k=1)

The pseudo gray level data y_{RA} (2, 1, 1) is defined as follows.

An input gray level data u_{RA} (2, 1, 1), which is “11111001”, is inputted to the pseudo gray level processor 3₁. Since i=2, the state variable data x_{RA} (2, 1, 1) is given by:

$${x}_{RA} ( 2 , 1 , 1 ) = {v}_{RA} ( 1 , 1 , 1 ) \\ = '' 01 '' .$$

For u_{RA}^{L} (2, 1, 1) being “01”, the carry data CRY_{RA} (2, 1, 1), which is the carry-over bit (carry bit) of the sum of the lower bit data u_{RA}^{L} (2, 1, 1) and the state variable data x_{RA} (2, 1, 1), is given by

CRY_{RA} (2, 1, 1)=“0”.

The pseudo gray level data y_{RA} (2, 1, 1) is defined in accordance with Case 2-1. The pseudo gray level data y_{RA} (2, 1, 1) is given by

y_{RA} (2, 1, 1)=“111110”.

As shown in FIG. 9, the least significant bit y_{RA}^{LSB} (2, 1, 1) is given by

y_{RA} (2, 1, 1)=“0”.

In the meantime, a value v_{RA} (2, 1, 1) is given by

$${v}_{RA} ( 2 , 1 , 1 ) = {x}_{RA} ( 2 , 1 , 1 ) + {u}_{RA}^{L} ( 2 , 1 , 1 ) \\ = '' 10 '' .$$

Also, the value W_{RA} is maintained in its original state. Therefore, for i being 3, the value W_{RA} is given by

W_{RA}=“0”.

Pixel 8_{5, 1} During the First Frame (i=3, j=k=1)

In the same way of the pixel 8_{3, 1}, the state variable data x_{RA}, the carry data CRY_{RA}, the pseudo gray level data y_{RA}, and the LSB y_{RA}^{LSB} are given by:

x_{RA} (3, 1, 1)=“10”,

CRY_{RA} (3, 1, 1)=0,

y_{RA} (3, 1, 1)=“111110”,

y_{RA}^{LSB} (3, 1, 1)=“0”,

and

v_{RA} (3, 1, 1)=“11”.

Also, the value W_{RA} is maintained in its original state. For i being 4, the value W_{RA} is given by

W_{RA}=“0”.

Pixel 8_{7, 1} During the First Frame (i=4, j=k=1)

In the same way, the state variable data x_{RA} (4, 1, 1) is given by

$${x}_{RA} ( 4 , 1 , 1 ) = {v}_{RA} ( 3 , 1 , 1 ) \\ = '' 11 '' .$$

For u_{RA}^{L} (4, 1, 1) being “01”, a carry-over is induced when the state variable data x_{RA} (4, 1, 1) and the lower bit u_{RA}^{L} (4, 1, 1) are summed. As shown in FIG. 9, the carry data CRY_{RA} (4, 1, 1) is given by

CRY_{RA} (4, 1, 1)=“1”.

In the meantime, the pseudo gray level data y_{RA} (4, 1, 1) is defined in accordance with the case 2-2. As shown in FIG. 9, the pseudo gray level data y_{RA} (4, 1, 1) is given by

y_{RA}^{H} (4, 1, 1)=“11111”,

y_{RA}^{LSB} (4, 1, 1)=W_{RA},

where y_{RA}^{H} (4, 1, 1) is the upper m−1 bits of the pseudo gray level data y_{RA} (4, 1, 1), and y_{RA}^{LSB} (4, 1, 1) is the LSB of y_{RA}⁽4, 1, 1). Since W_{RA}=0, as shown in FIG. 9, y_{RA}^{LSB} (4, 1, 1) is given by

y_{RA}^{LSB} (4, 1, 1)=“0”.

Once the LSB y_{RA}^{LSB} is defined in accordance with the value W_{RA} stored in the counter 37a, the value W_{RA} is toggled. That is, the value W_{RA} is toggled for each state of the case 2-2 or the case 3-1. In a case of i=5, as shown in FIG. 9, the value W_{RA} is given by

W_{RA}=“1”.

In the meantime, a value v_{RA} (4, 1, 1) is given by

$${v}_{RA} ( 4 , 1 , 1 ) = {x}_{RA} ( 4 , 1 , 1 ) + {u}_{RA}^{L} ( 4 , 1 , 1 ) \\ = '' 00 '' .$$

Pixels 8_{9, 1}, 8_{11, 1} and 8_{13, 1} During the First Frame (5≦i≦7, j=k=1)

In all cases when 5≦i≦7, the pseudo gray level data y_{RA} (i, 1, 1) is calculated in accordance with Case 2-1, and the pseudo gray level data y_{RA} (i, 1, 1) and the LSB thereof are given by

y_{RA} (i, 1, 1)=“111110”,

y_{RA}^{LSB} (i, 1, 1)=“0”.

The values v_{RA} (i, 1, 1) for i being 5 to 7 are similarly given by

v_{RA} (5, 1, 1)=“01”,

v_{RA} (6, 1, 1)=“10”,

v_{RA} (7, 1, 1)=“11”.

Also, all the cases when i=5 to 7 do not correspond to any one of Case 2-2 and Case 3-1. Thus, the value W_{RA} is maintained in its original state. That is, in a case of i=8, the value W_{R} is given by

W_{RA}=“1”.

Pixel 8_{15, 1} During the First Frame (i=8, j=k=1)

A state variable data x_{RA} (8, 1, 1) is similarly given by

$${x}_{RA} ( 8 , 1 , 1 ) = {v}_{RA} ( 7 , 1 , 1 ) \\ = '' 11 '' .$$

Since u_{RA}^{L} (8, 1, 1)=“01”, a carry-over is induced when the state variable data x_{RA} (8, 1, 1) and a lower bit u_{RA}^{L} (8, 1, 1) are summed. As shown in FIG. 9, the carry data CRY_{RA} (8, 1, 1) is given by

CRY_{RA} (8, 1, 1)=“1”.

In the meantime, the pseudo gray level data y_{RA} (8, 1, 1) is defined in accordance with Case 2-2. That is, as shown in FIG. 8, the pseudo gray level data y_{RA} (8, 1, 1) is given by:

y_{RA}^{H} (8, 1, 1)=“11111”,

y_{RA}^{LSB} (8, 1, 1)=W_{RA}.

Since W_{RA}=“1” as shown in FIG. 9, the LSB of the pseudo gray level data y_{RA} (8, 1, 1) is given by:

y_{RA} (8, 1, 1)=“1”.

Once the LSB y_{RA}^{LSB} is defined in accordance with the value W_{RA}, the value W_{RA} is toggled. Therefore, the value W_{RA} is given by:

W_{RA}=“0”

Hereafter, similarly, each time the input gray level data u_{RA} and the carry data CRY_{RA} correspond to Case 2-2 or Case 3-1, the LSB y_{RA}^{LSB} alternately repeats “0” and “1”.

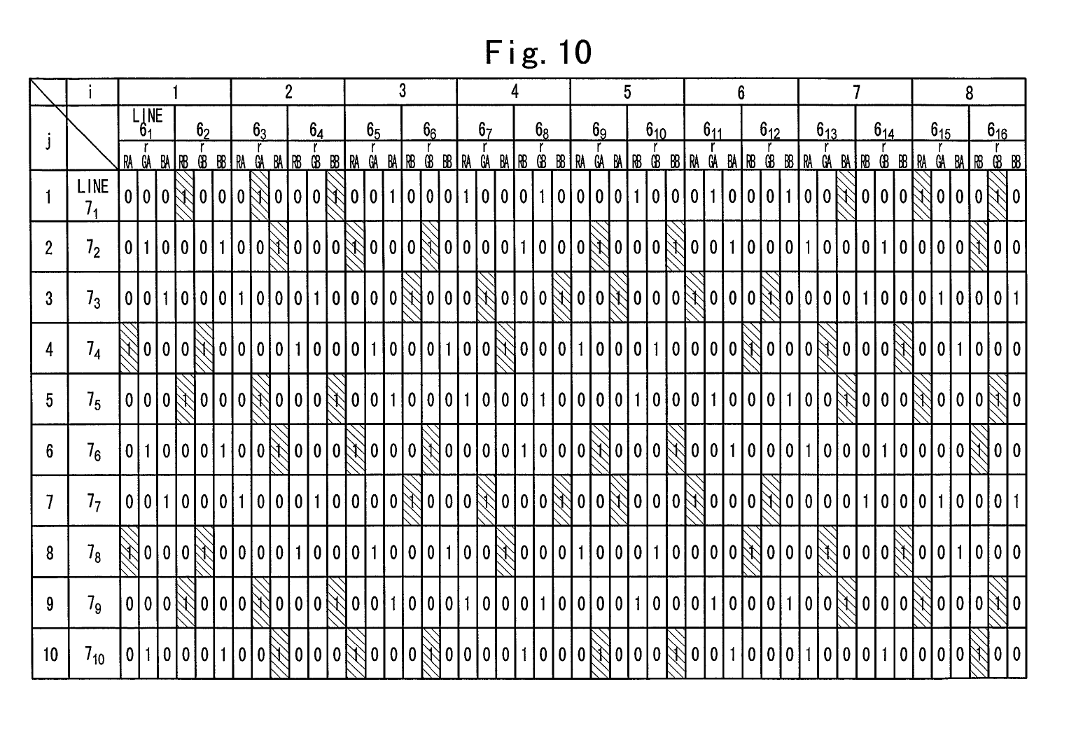

For other r and j, the LSB y_{RA}^{LSB} and the carry data CRYᵣ (i, j, k) are similarly defined. FIG. 10 shows the LSB yᵣ^{LSB} (i, j, 1) of a pseudo gray level data yᵣ (i, j, 1) and the carry data CRYᵣ (i, j, 1) during the first frame in a case when uᵣ (i, j, k)=“11111001”. In FIG. 10, values “0” and “1” indicate that the carry data CRYᵣ (i, j, 1) are at “0” and “1”, respectively. Also, the fact that the “0”s and “1”s are hatched implies that the LSBs yᵣ^{LSB} (i, j, 1) are at “1”. Moreover, the fact that the “0”s and “1”s are not hatched implies that the LSB yᵣ^{LSB} (i, j, 1) are at “0”.

The case when uᵣ (i, j, k)=“11111001” corresponds to Case 2, as mentioned above. A combination of i and j in which the carry data CRYᵣ (i, j, 1) is at “0” corresponds to Case 2-1. In this case, the pseudo gray level data yᵣ is given by:

yᵣ^{LSB} (i, j, 1)=“111110”

That is, the LSB yᵣ^{LSB} is given by:

yᵣ^{LSB} (, j, 1)=“0”

On the other hand, a combination of i and j in which the carry data CRYᵣ (i, j, 1) is at “1” corresponds to Case 2-2. In this case, The LSB yᵣ^{LSB} alternately repeats “0” and “1” each time the CRYᵣ (i, j, 1) is at “1”.

For example, let us consider the case of r=“RA” and j=1. The carry data CRY_{RA} is at “1” in a case when i is 4 or 8. At the time of i being 4, the LSB yᵣ^{LSB} (4, 1, 1) is at “1”. At the time of I being 8, the LSB yᵣ^{LSB} (8, 1, 1) is at “0”. In another r and j, the same operation is executed.

### Operation Example 2

In Operational Example 2, a process for generating the pseudo gray level data yᵣ (i, j, k) is described for the case when the input gray level data uᵣ (i, j, k) is given by

uᵣ (i, j, k)=“11111110”,

that is,

uᵣ (i, j, k)=254,

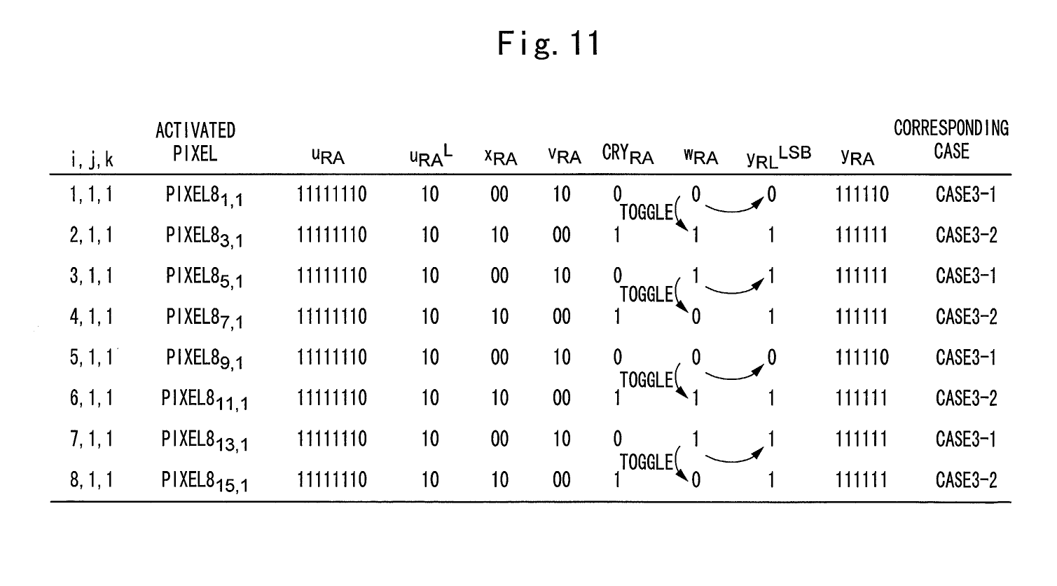

The case when uᵣ (i, j, k)=“11111110” corresponds to Case 3. Also, it is assumed that r is “RA”, that is, the process for generating a pseudo gray level data y_{RA} (i, j, k) will be described in the following. FIG. 11 shows the state variable data x_{RA}, the value v_{RA} and the carry data CRY_{RA}, the value W_{RA}, the pseudo gray level data y_{RA} to be finally generated; and the LSB y_{RA}^{LSB}. FIG. 11 shows x_{RA}, v_{RA}, CRY_{RA}, W_{RA}, y_{RA} and y_{RA}^{LSB} when i is an integer between 1 and 8. The operation of the pseudo gray level processors 3 will be described below with reference to FIG. 11.

Pixel 8_{1, 1} During the First Frame (i=j=k=1)

At first, the initial state variable data x_{RA}^{INI} (1, 1) and the initial value W_{RA}^{INI} (1, 1) are defined. With reference to FIG. 6, the initial state variable data x_{RA}^{INI} (1, 1) is given by

x_{RA}^{INI} (1, 1)=“00”.

Also, with reference to FIG. 7, the initial value W_{RA}^{INI} (1, 1) is given by

W_{RA}^{INI} (1, 1)=“0”.

The value W_{RA} is defined by

W_{RA}=“0”

The pseudo gray level data y_{RA} (1, 1, 1) is defined as follows.

The input gray level data u_{RA} (1, 1, 1), which is “11111110”, is inputted to the pseudo gray level processor 3₁. Since i=1, the state variable data x_{RA} (1, 1, 1) is defined as being the initial state variable data x_{RA}^{INI} (1, 1) generated by the initial value setting circuit 35. That is, the state variable data x_{RA} (1, 1, 1) is given by

$${x}_{RA} ( 1 , 1 , 1 ) = {x}_{RA}^{INI} ( 1 , 1 ) \\ = '' 00 '' .$$

A lower bit data u_{RA}^{L} (1, 1, 1), which is lower two bits of the input gray level data u_{RA}^{L} (1, 1, 1), is given by

u_{RA}^{L} (1, 1, 1)=“10”.

The carry data CRY_{RA} (1, 1, 1), which is the carry-over bit (carry bit) of the sum of the lower bit data u_{RA}^{L} (1, 1, 1) and the state variable data x_{RA} (1, 1, 1), is given by

CRY_{RA} (1, 1, 1)=“0”,

The pseudo gray level data y_{RA} (1, 1, 1) is defined in accordance with Case 3-1. That is, as shown in FIG. 8, The pseudo gray level data y_{RA} (1, 1, 1) is given by:

y_{RA}^{H} (1, 1, 1)=“11111”

y_{RA}^{LSB} (1, 1, 1)=W_{RA}

Since W_{RA}=“0”, as shown in FIG. 11, the LSB y_{RA}^{LSB} of the pseudo gray level data y_{RA} is given by:

y_{RA}^{LSB} (1, 1, 1)=“0”

Once the least significant bit y_{RA}^{LSB} is defined in accordance with the value W_{RA}, the value W_{RA} is toggled. That is, the value W_{RA} is toggled for each state of Case 2-2 or Case 3-1. For i being equal to or more than 2, the value W_{RA} is given by:

W_{RA}=“1”.

Next, when the LSB y_{RA}^{LSB} is defined on the basis of the value W_{RA}, and

y_{RA}^{LSB}=“1”.

In the meantime, the value v_{RA} (1, 1, 1) is given by

$${v}_{RA} ( 1 , 1 , 1 ) = {x}_{RA} ( 1 , 1 , 1 ) + {u}_{RA}^{L} ( 1 , 1 , 1 ) \\ = '' 10 '' .$$

Pixel 8_{3, 1} During the First Frame (i=2, j=k=1)

The pseudo gray level data y_{RA} (2, 1, 1) is defined as follows. The input gray level data u_{RA} (2, 1, 1), which is “11111001”, is inputted to the pseudo gray level processor 3₁. Since i=2, the state variable data x_{RA} (2, 1, 1) is given by

$${x}_{RA} ( 2 , 1 , 1 ) = {v}_{RA} ( 1 , 1 , 1 ) \\ = '' 10 '' .$$

Also, since u_{RA}^{L} (2, 1, 1)=“10”, the sum of the lower bit data u_{RA}^{L} (2, 1, 1) and the state variable data x_{RA} (2, 1, 1) leads to the generation of the carry-over. The carry data CRY_{RA} (2, 1, 1), which is the carry-over bit (carry bit), is given by

CRY_{RA} (2, 1, 1)=“1”.

The pseudo gray level data y_{RA} (2, 1, 1) is defined in accordance with Case 3-2. That is, as shown in FIG. 8, the pseudo gray level data y_{RA} (2, 1, 1) is given by

y_{RA} (2, 1, 1)=“111111”.

That is, the LSB y_{RA}^{LSB} (2, 1, 1) is given by

y_{RA}^{LSB} (2, 1, 1)=“1”.

On the other hand, the value v_{RA} (2, 1, 1) is given by

$${v}_{RA} ( 2 , 1 , 1 ) = {x}_{RA} ( 2 , 1 , 1 ) + {u}_{RA}^{L} ( 2 , 1 , 1 ) = {}_{}^{``}{00}{}_{}^{″} .$$

Pixel 8_{5, 1} of First Frame (i=3, j=k=1)

A pseudo gray level data y_{RA} (3, 1, 1) is defined as follows. An input gray level data u_{RA} (4, 1, 1), which is “11111001”, is inputted to the pseudo gray level processor 3₁. The state variable data x_{RA} (3, 1, 1) is given by

$${x}_{RA} ( 3 , 1 , 1 ) = {v}_{RA}^{INI} ( 2 , 1 , 1 ) = {}_{}^{``}{00}{}_{}^{″} .$$

A lower bit data u_{RA}^{L} (3, 1, 1), which is lower two bits of the input gray level data u_{RA}^{L} (3, 1, 1), is given by

u_{RA}^{L} (3, 1, 1)=“10”.

As shown in FIG. 11, the carry data CRY_{RA} (3, 1, 1), which is the carry-over bit (carry bit) of the sum of the lower bit data u_{RA}^{L} (3, 1, 1) and the state variable data x_{RA} (3, 1, 1), is given by

CRY_{RA} (1, 1, 1)=“0”.

The pseudo gray level data y_{RA} (3, 1, 1) is defined in accordance with Case 3-1. That is, as shown in FIG. 8, the pseudo gray level data y_{RA} (3, 1, 1) are given by

y_{RA}^{H} (3, 1, 1)=“11111”

y_{RA}^{LSB} (3, 1, 1)=W_{RA}

Since W_{RA}=“1”, as shown in FIG. 11, the LSB of pseudo gray level data y_{RA} (3, 1, 1) is given by

y_{RA}^{LSB} (3, 1, 1)=“1”.

Once the LSB y_{RA}^{LSB} is defined in accordance with the value W_{RA}, the value W_{RA} is toggled. For i being 4 or more, the value W_{RA} is given by

W_{RA}=“0”.

On the other hand, the value v_{RA} (3, 1, 1) is given by

$${v}_{RA} ( 3 , 1 , 1 ) = {x}_{RA} ( 3 , 1 , 1 ) + {u}_{RA}^{L} ( 3 , 1 , 1 ) = {}_{}^{``}{10}{}_{}^{″} .$$

Pixel 8_{7, 1} of First Frame (i=4, j=k=1)

The pseudo gray level data y_{RA} (4, 1, 1) is defined as follows. The input gray level data u_{RA} (4, 1, 1), which is “11111001”, is inputted to the pseudo gray level processor 3₁. The state variable data x_{RA} (4, 1, 1) is given by

$${x}_{RA} ( 4 , 1 , 1 ) = {v}_{RA} ( 3 , 1 , 1 ) = {}_{}^{``}{10}{}_{}^{″} .$$

Also, since u_{RA}^{L} (4, 1, 1)=“10”, the sum of the lower bit data u_{RA}^{L} (4, 1, 1) and the state variable data x_{RA} (4, 1, 1) leads to a carry-over. The carry data CRY_{RA} (4, 1, 1), which is the carry-over bit (carry bit), is given by

CRY_{RA} (4, 1, 1)=“1”.

The pseudo gray level data y_{RA} (4, 1, 1) is defined in accordance with the case 3-2. That is, as shown in FIG. 8, the pseudo gray level data y_{RA} (4, 1, 1) is given by

y_{RA} (4, 1, 1)=“111111”.

As shown in FIG. 11, the LSB y_{RA}^{LSB} (4, 1, 1) is given by

y_{RA}^{LSB} (4, 1, 1)=“1”.

On the other hand, the value v_{RA} (4, 1, 1) is given by

$${v}_{RA} ( 4 , 1 , 1 ) = {x}_{RA} ( 4 , 1 , 1 ) + {u}_{RA}^{L} ( 4 , 1 , 1 ) = {}_{}^{``}{00}{}_{}^{″} .$$

For other r, j, and k, the LSB y_{RA}^{LSB} and the carry data CRYᵣ (i, j, k) are defined in the same way.

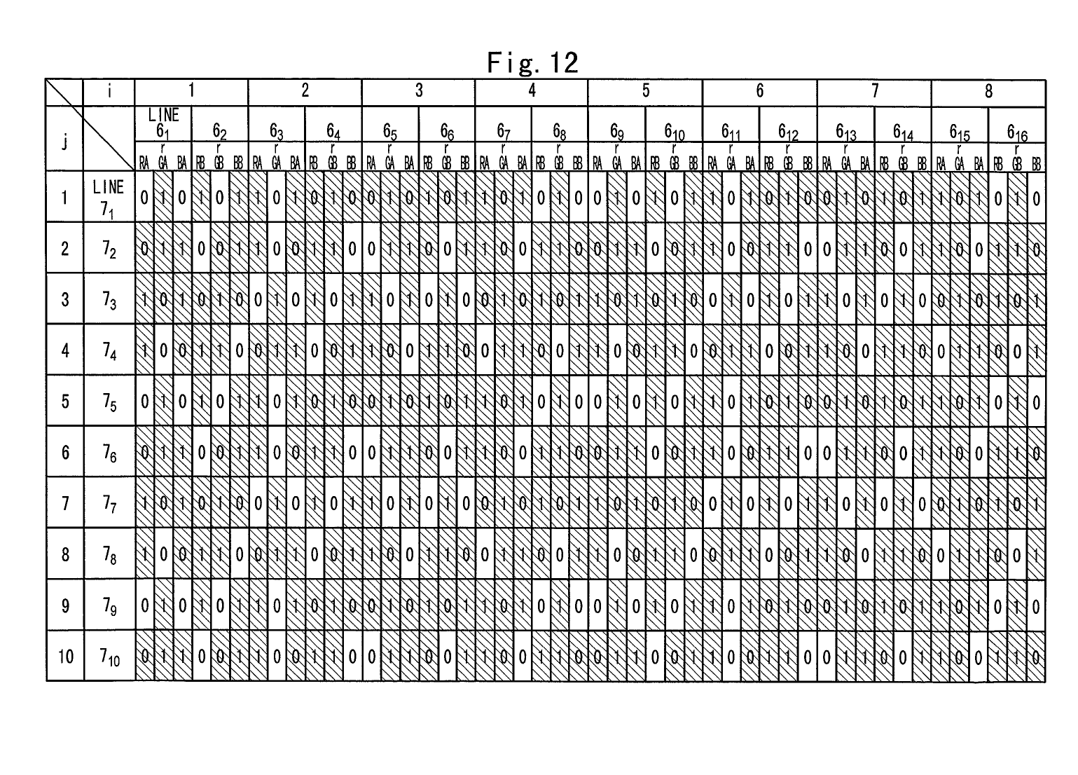

FIG. 12 shows the least significant bit yᵣ^{LSB} (i, j, 1) and the carry data CRYᵣ (i, j, k) during the first frame in the case when uᵣ (i, j, k)=“11111110”. As for FIG. 12, similarly to FIG. 10, the values “0” and “1” indicate that the carry data CRYᵣ (i, j, 1) are at “0” and “1”, respectively. Also, in FIG. 12, the fact that the values “0” and “1” are hatched implies that the least significant bit yᵣ^{LSB} (i, j, 1) is at “1”. Moreover, the fact that the values “0” and “1” are not hatched implies that the LSB yᵣ^{LSB} (i, j, 1) is “0”. The operation of the pseudo gray level processors 3 will be described below with reference to FIG. 12.

The case when uᵣ (i, j, k)=“11111110” corresponds to Case 3, as mentioned above. The combination of i and j in which the carry data CRYᵣ (i, j, 1 ) is at “0” corresponds to Case 3-1. In this case, the LSB yᵣ^{LSB} alternately repeats “0” and “1” each time the carry data CRYᵣ (i, j, 1) is at “0”.

For example, let us consider the case when r=“RA” and j=1. The carry data CRY_{RA} is at “0” in the case when i=1, 3, 5, 7 . . . In the case when i=1, 5, the LSB yᵣ^{LSB} (4, 1, 1) is at “1”. In the case when i=3, 7, the LSB yᵣ^{LSB} (8, 1, 1) is at “0”. In this way, the LSB yᵣ^{LSB} (8, 1, 1) alternately repeats “0” and “1” each time the CRYᵣ (i, j, 1) is at “0”. For other r and j, the same operation is executed.

On the other hand, the combination of i and j in which the carry data CRYᵣ (i, j, 1) is at “1” corresponds to Case 3-2. In this case, the pseudo gray level data yᵣ is given by

yᵣ (i, j, 1)=“111111”

That is, the LSB bit yᵣ^{LSB} is given by:

yᵣ^{LSB} (i, j, 1)=“1”.

As mentioned above, the voltage applied to each pixel 8 is determined on the basis of the pseudo gray level data yᵣ. At this time, the pseudo gray level data yᵣ generated for Case 2 and Case 3 is short of the contrast. Therefore, the voltage determined correspondingly to the pseudo gray level data yᵣ generated for Case 2 and Case 3 is desired to be in the following range.

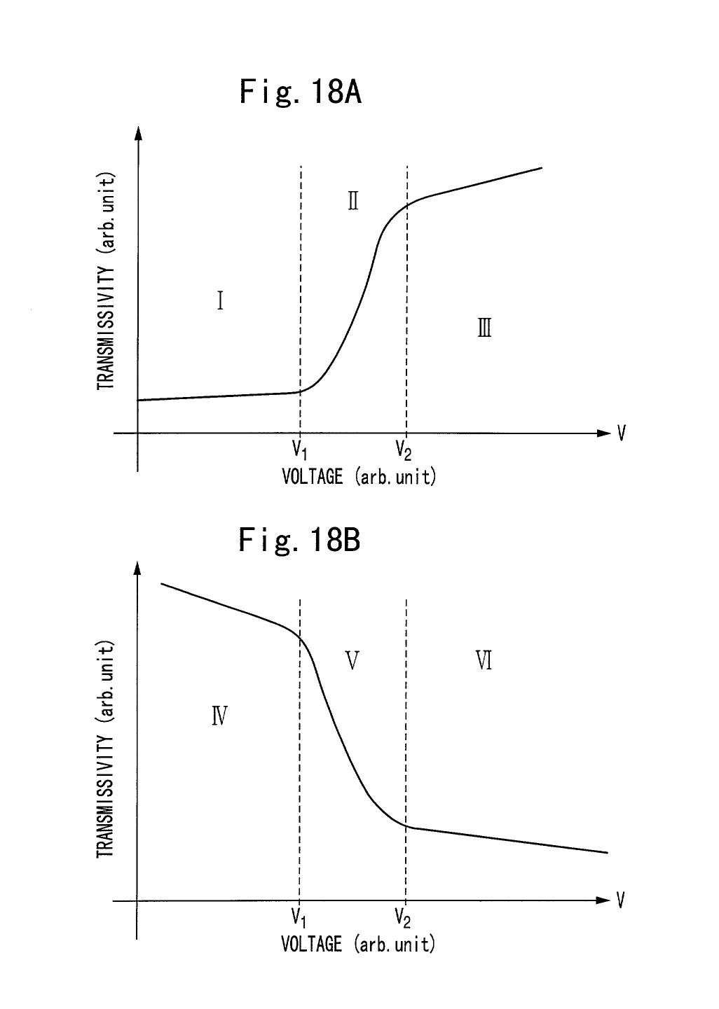

FIGS. 18A and 18B are views showing a voltage applied to the pixels 8, and a transmissivity of liquid crystal constituting the pixels 8. FIG. 18A shows the transmissivity of the liquid crystal constituting the pixels 8 depending on the voltage applied to pixels 8 when the pixel 8 is composed of the liquid crystal having a lower transmissivity as the voltage is lower, namely, the pixels 8 are normally black.

The transmissivity of the liquid crystal constituting the pixel 8 exhibits the dependencies, which are different in three regions of a I region, a II region and a III region, depending on the voltages. In the I region in which the voltage applied to the pixel 8 is lower than a voltage V₁, as the voltage is higher, the transmission rate is gradually increased. In the II region in which the voltage applied to the pixel 8 is higher than the voltage V₁ and lower than a voltage V₂, as the voltage is higher, the transmissivity is increased more sharply than in the I region. In the III region in which the voltage applied to the pixels 8 is higher than the voltage V₂, a ratio of the increase in the transmission rate to the voltage applied to the pixel 8 is lower than that of the II region.

If the pixels 8 are composed of the liquid crystal exhibiting such property, the voltage determined correspondingly to the pseudo gray level data yᵣ generated for Case 2 and Case 3 is desired to be the voltage in the I region or the III region. Such determination of the voltage improves the contrast of the LCD 1.

The similar discussion can be established when the pixels 8 are composed of the liquid crystal having the lower transmissivity as the voltage is higher, namely, when the pixel 8 is normally white. FIG. 18B shows a voltage applied to the pixels 8 and the transmissivity of the liquid crystal constituting the pixel 8 when the pixels 8 are normally white. For the pixels 8 being normally white, the voltage determined correspondingly to the pseudo gray level data yᵣ generated for Case 2 and Case 3 is desired to be a voltage in a IV region or a VI region whose change rate of a transmission rate to a voltage is lower than that of a V region shown in FIG. 18B.

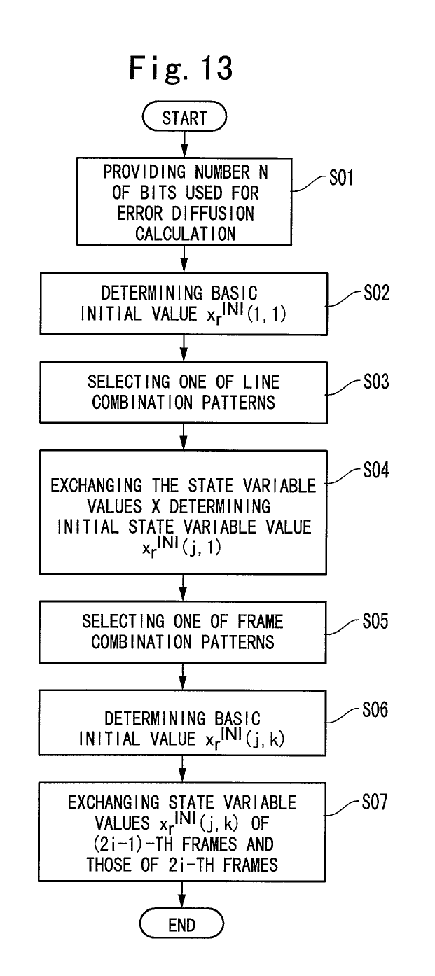

The above-mentioned method of defining the initial state variable data xᵣ^{INI} has an influence on a generation of a fixed pattern shown on the LCD 1. The content of the initial value determiner ROM 35a that is referred to in generating the initial state variable data xᵣ^{INI} shown in FIG. 6 is defined in accordance with an initializing method shown in FIG. 13, which reduces the generation of the fixed pattern. The initializing method will be described below with reference to FIG. 13.

Step S01:

The number N of bits used for error diffusion calculation is given. The number m of the bits in the pseudo gray level is a difference the number n of bits in an input gray level data uᵣ minus the number m of bits in a pseudo gray level data yᵣ. The number N is given by

N=n−m.

A step S02 is carried out following the step S01.

Step S02:

A basic initial value is defined which is an initial state variable data xᵣ^{INI} (1, 1) for the first line 7₁ during the first frame. The basic initial value is defined such that the initial state variable data x_{RA}^{INI} (1, 1) and x_{RB}^{INI} (1, 1) are different, x_{GA}^{INI} (1, 1) and x_{GB}^{INI} (1, 1) are different, and x_{BA}^{INI} (1, 1) and x_{BB}^{INI} (1, 1) are different. In this embodiment, as shown in the line 41_{1, 1} of FIG. 6, they are defined as follows:

x_{RA}^{INI} (1, 1)=0,

x_{GA}^{INI} (1, 1)=2,

x_{BA}^{INI} (1, 1)=1,

x_{RB}^{INI} (1, 1)=3,

x_{GB}^{INI} (1, 1)=0,

and

x_{BB}^{INI} (1, 1)=2.

A step S03 is carried out following the step S02.

Step S03:

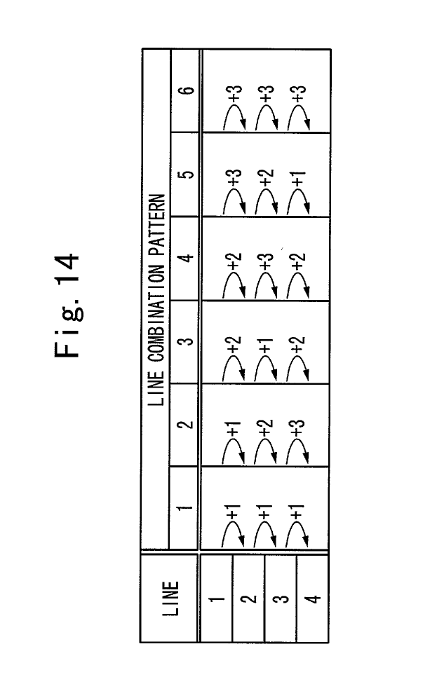

One of line combination patterns shown in FIG. 14 is selected. In this embodiment, it is assumed that the combination pattern 1 is selected. A step S04 is carried out following the step S03.

Step S04:

An initial state variable data xᵣ^{INI} (j, 1) is defined for each lateral line 7, in accordance with the combination pattern 1 selected at the step S03.

The initial state variable data xᵣ^{INI} (j, 1) have the same value for each four lateral lines 7. That is, initial state variable data xᵣ^{INI} (j, 1) defined for a lateral line 7ⱼ with j being 4t+1 are same, where t is an integer of 0 or more. Similarly, initial state variable data xᵣ^{INI} (j, 1) defined for a lateral line 7ⱼ with j being 4t+2, a lateral line 7ⱼ with j being 4t+3 and a lateral line 7ⱼ with j being 4t+4 are respectively same. This fact is represented such that the initial state variable data xᵣ^{INI} (j, 1) has a four-line cycle.

The initial state variable data xᵣ^{INI} (j, 1) shown in FIG. 6 are defined in accordance with the combination pattern 1, as given by a next equation group:

xᵣ^{INI} (4t+2, 1)=xᵣ^{INI} (4t+1, 1)+1,

xᵣ^{INI} (4t+3, 1)=xᵣ^{INI} (4t+2, 1)+1,

and

xᵣ^{INI} (4t+4, 1)=xᵣ^{INI} (4t+3, 1)+1

where t is a natural number of 0 or more. Thus, the initial state variable data xᵣ^{INI} (4t+1, 1), xᵣ^{INI} (4t+2, 1), xᵣ^{INI} (4t+3, 1) and xᵣ^{INI} (4t+4, 1) are defined as being values different from each other. A step S05 is carried out following the step S04.

Step S05:

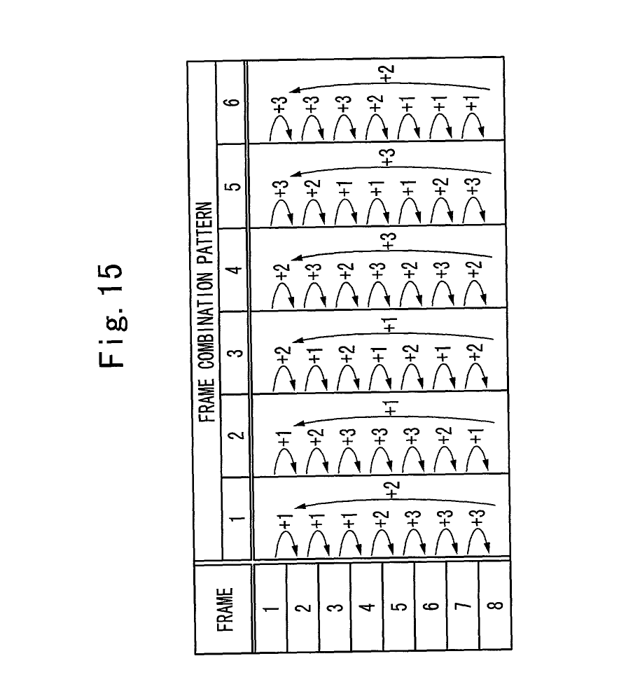

One of frame combination patterns shown in FIG. 15 is selected. In this embodiment, it is assumed that a combination pattern 4 shown in FIG. 15 is selected. A step S06 is carried out following the step S05.

Step S06:

An initial state variable data xᵣ^{INI} (j, k) is defined for each frame, in accordance with the combination pattern 4 selected at the step S05.

The initial state variable data xᵣ^{INI} (j, k) have the same value for each eight frames. That is, an initial state variable data xᵣ^{INI} (j, k) are same which are defined for k-th frames of k=8s+1. Here, s is an integer of 0 or more. Similarly, initial state variable data xᵣ^{INI} (j, k) are same which are respectively defined for a k-th frame of j=8s+2, a k-th frame of j=8s+3, a k-th frame of 8s+4, a k-th frame of k=8s+5, a k-th frame of k=8s+6, a k-th frame of k=8s+7 and a k-th frame of 8s+8. This fact is represented such that the initial state variable data xᵣ^{INI} (j, k) has an eight-frame cycle.

The initial state variable data xᵣ^{INI} (j, 1) shown in FIG. 6 are defined in accordance with the combination pattern 4, as given by a next equation group:

xᵣ^{INI} (j, 8s+2)=xᵣ^{INI} (j, 8s+1)+2,

xᵣ^{INI} (j, 8s+3)=xᵣ^{INI} (j, 8s+2)+3,

xᵣ^{INI} (j, 8s+4)=xᵣ^{INI} (j, 8s+3)+2,

xᵣ^{INI} (j, 8s+5)=xᵣ^{INI} (j, 8s+4)+3,

xᵣ^{INI} (j, 8s+6)=xᵣ^{INI} (j, 8s+5)+2,

xᵣ^{INI} (j, 8s+7)=xᵣ^{INI} (j, 8s+6)+3,

and

xᵣ^{INI} (j, 8s+8)=x_{INI} (j, 8s+7)+2.

A step S07 is carried out following the step S06, as shown in FIG. 13.

Step S07:

The initial state variable data xᵣ^{INI} (j, k) of odd-numbered frames and the initial state variable data xᵣ^{INI} (j, k) of even-numbered frames are replaced in the former four frames and the latter four frames.

This results in the round of the initial state variable data xᵣ^{INI} in the first to fourth frames. Moreover, the initial state variable data xᵣ^{INI} are defined such that the respective initial state variable data xᵣ^{INI} in the first frame and the sixth frames, the second frame and the fifth frame, the third frame and the eighth frame, and the fourth frame and the seventh frame are equal to each other. Accordingly, the fixed pattern is hard to be induced in the picture displayed by the LCD 1.

As mentioned above, the pseudo gray level processors 3 in the first embodiment allows the m-bit pseudo gray level data yᵣ (i, j, k) to indicate the 2ⁿ gray levels in the pseudo manner. Moreover, the generation of the initial state variable data xᵣ^{INI} based on the above-mentioned method enables the fixed pattern to be hard to be induced in the picture displayed by the LCD 1.

In the first embodiment, the LCD 1 may be another display apparatus that is driven on the basis of a digitized input picture signal, for example, such as PDP.

### Second Embodiment

A display apparatus according to a second embodiment has the configuration similar to that of the display apparatus of the first embodiment. In the display apparatus of the second embodiment, the method of generating the pseudo gray level data yᵣ on the basis of the input gray level data uᵣ is different from that of the display apparatus of the first embodiment. In the second embodiment, the above-mentioned value vᵣ is calculated by subtracting the state variable data xᵣ from the lower bit data uᵣ^{L}, which is the lower (n−m) bits of the input gray level data uᵣ. Moreover, in the second embodiment, the carry data CRYᵣ is generated depending on whether or not the carry-over is induced when the state variable data xᵣ is subtracted from the lower bit data uᵣ^{L}.

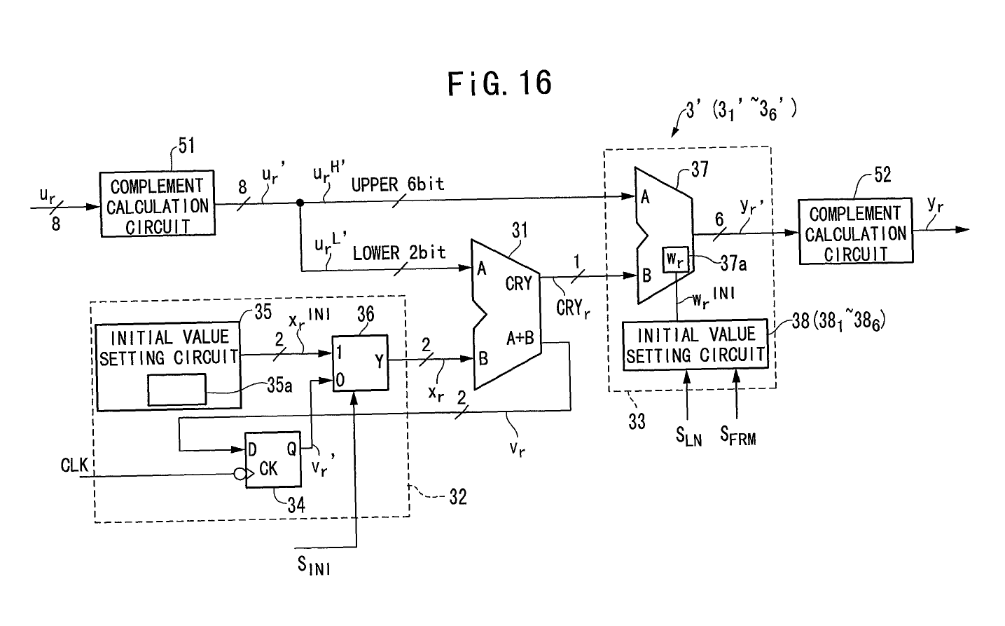

In accordance with the operation, the pseudo gray level processors 3₁-3₆ of the display apparatus in the first embodiment are replaced by pseudo gray level processors 3₁′-3₆′ shown in FIG. 16. The pseudo gray level processors 3₁′-3₆′ are referred to as a pseudo gray level processors 3′. The other units of the display apparatus in the second embodiment have the same configuration as the first embodiment and carries out the same operation as the first embodiment.

As shown in FIG. 16, the pseudo gray level processor 3′ has the configuration similar to that of the pseudo gray level processor 3. The pseudo gray level processor 3′ has the configuration in which complement calculation circuits 51, 52 are added to the pseudo gray level processor 3. The complement calculation circuit 51 calculates a complement input gray level data uᵣ′ implying a complement of the input gray level data uᵣ.

The adder 31 adds a complement lower bit data uᵣ^{L}′, which is lower order (n−m) bits of the complement input gray level data uᵣ′, and a state variable data xᵣ, and outputs a value vᵣ.

Moreover, if the sum of the complement lower bit data uᵣ^{L}′ and the state variable data xᵣ results in the generation of the carry-over, the adder 31 sets a carry data CRYᵣ to “1” output to the pseudo gray level calculator 33. If there is no generation of the carry-over, the adder 31 sets the carry data CRYᵣ to “0” output to the pseudo gray level calculator 33.

The state variable data generator 32 generates the state variable data xᵣ on the basis of the value vᵣ. The process when the state variable data generator 32 generates the state variable data xᵣ is the same as the first embodiment. Detailed explanation of state variable data generator 32 is not given.

The pseudo gray level data calculator 33 generates a complement pseudo gray level data yᵣ′ on the basis of a complement upper bit data uᵣ^{H}′ and the carry data CRYᵣ. Here, the complement upper bit data uᵣ^{H}′ is upper m bits of the complement input gray level data uᵣ′. The complement pseudo gray level data yᵣ′ is a complement of a pseudo gray level data yᵣ to be finally generated. In the second embodiment, the process for generating the complement pseudo gray level data yᵣ′ on the basis of the complement upper bit data uᵣ^{H}′ is the same as the process for generating the pseudo gray level data yᵣ on the basis of the upper bit data uᵣ^{H}. Therefore, the detailed explanation is not done. The pseudo gray level data calculator 33 outputs the complement pseudo gray level data yᵣ′ to the complement calculation circuit 52. The complement calculation circuit 52 calculates a complement of the complement pseudo gray level data yᵣ′ and generates the pseudo gray level data yᵣ.

In the second embodiment, the pseudo gray level processor 3′ performs the same calculation as the first embodiment, on the complement of the input gray level data uᵣ to calculate the complement pseudo gray level data yᵣ′. Then, the pseudo gray level processor 3′ calculates the complement of the complement pseudo gray level data yᵣ′ and generates the pseudo gray level data yᵣ.

The above mentioned operation corresponds to the operation in which all the additions done in the first embodiment are replaced by the subtractions. That is, in the second embodiment, the value vᵣ is generated by subtracting the state variable data xᵣ from the lower bit data uᵣ^{L}. The carry data CRYᵣ is set to “1” if the carry-over is induced at a time of the subtraction, and the carry data CRYᵣ is set to “0” if the carry-over is not induced. Moreover, the calculation for adding the upper bit data uᵣ^{H} and the carry data CRYᵣ, which is done in the gray level corresponding to Case 1 of the first embodiment is replaced by the calculation for subtracting the carry data CRYᵣ from the upper bit data uᵣ^{H}.

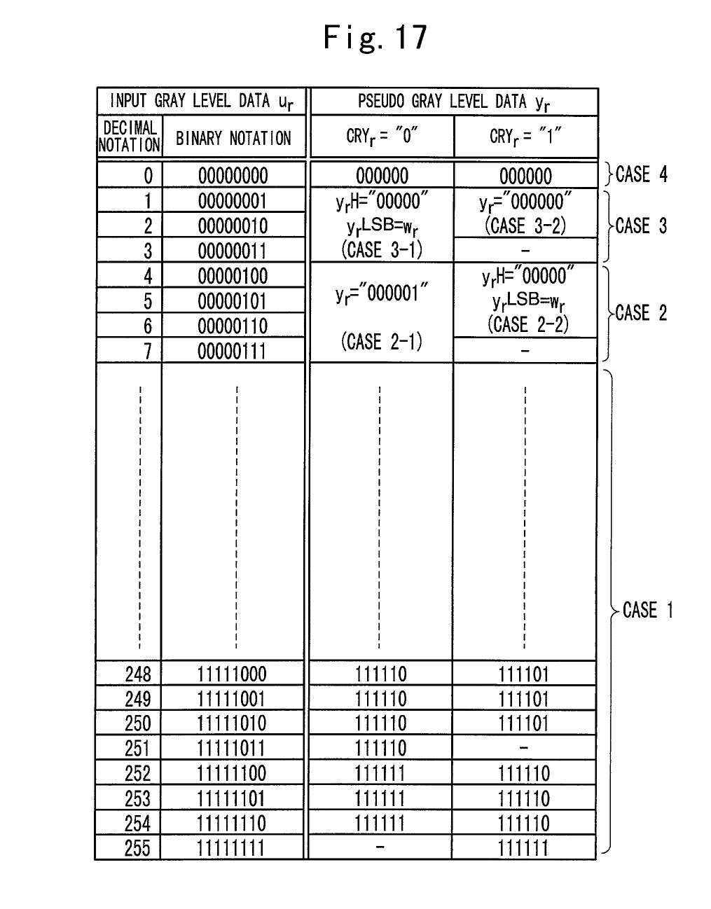

FIG. 17 shows the correspondence between the input gray level data uᵣ and the pseudo gray level data yᵣ in the second embodiment. The process for generating the pseudo gray level data yᵣ is classified into the following four cases.

Case 1

Case 1 is the case when at least one of the upper (m−1) bits of the input gray level data uᵣ (i, j, k) is at “1”.

Case 1 implies the case when uᵣ (i, j, k) given by the decimal notation is given by:

2^{(n-m+1)}≦uᵣ (i, j, k)≦2ⁿ−1

In this embodiment of n=8 and m=6, Case 1 is the case when

8≦uᵣ (i, j, k)≦255

In Case 1, the pseudo gray level data yᵣ (i, j, k) is defined by

yᵣ (i, j, k)=uᵣ^{H1} (i, j, k)−CRYᵣ (i, j, k)

where uᵣ^{H1} (i, j, k) is upper m bit of the input gray level data uᵣ (i, j, k).

Case 2

Case 2 is the case when all of the upper (m−1) bits of the input gray level data uᵣ (i, j, k) are at “0” and an m-th significant bit of the input gray level data uᵣ (i, j, k) is at “1”. In the embodiment of n=8 and m=6, Case 2 implies the case when

uᵣ^{H1} (i, j, k)=“000001”,

where uᵣ^{H1} (i, j, k) is the upper m bit of the input gray level data uᵣ (i, j, k).

When the input gray level data uᵣ (i, j, k) is given by the decimal notation, Case 2 is the case when

2^{(n-m)}≦uᵣ (i, j, k)≦2^{(n-m+1)}−1.

In this embodiment of n=8 and m=6, Case 2 is the case when

4≦uᵣ (i, j, k)≦7.

Case 2 is further classified into the following two cases, depending on the carry data CRYᵣ (i, j, k).

Case 2-1

Case 2-1 is the case when the carry data CRYᵣ (i, j, k) is “0”. In this case, the pseudo gray level data yᵣ (i, j, k) is defined by

yᵣ (i, j, k)=uᵣ^{H1} (i, j, k).

where uᵣ^{H1} (i, j, k) is the upper m bits of the input gray level data uᵣ (i, j, k), as mentioned above. In this embodiment, the pseudo gray level data yᵣ (i, j, k) is given by

yᵣ (i, j, k)=“000001”.

Case 2-2

Case 2-2 is the case when the carry data CRYᵣ (i, j, k) is “1”. In Case 2-2, the upper bit data yᵣ^{H} (i, j, k), which is the upper (m−1) bits of the pseudo gray level data yᵣ (i, j, k), is given by

yᵣ^{H} (i, j, k)=uᵣ^{H2} (i, j, k)

where uᵣ^{H2} (i, j, k) is the upper (m−1) bits of the input gray level data uᵣ (i, j, k). In this embodiment, the upper bit data yᵣ^{H} (i, j, k) is given by

yᵣ^{H} (i, j, k)=“00000”.

Moreover, the least significant bit data yᵣ^{LSB} (i, j, k), which is the LSB of the pseudo gray level data yᵣ (i, j, k), is given by

yᵣ^{LSB} (i, j, k)=Wᵣ.

As mentioned above, the value Wᵣ is stored in the counter 37a. The value Wᵣ is toggled each time the LSB yᵣ^{LSB} (i, j, k) is generated on the basis of the value Wᵣ. Thus, the least significant bit data yᵣ^{LSB} (i, j, k) becomes at “0” at the rate of once every two times, and becomes at “1” at the rate of once every two times.

When all the bits of the lower bit data uᵣ^{L} (i, j, k), which is the lower (n−m) bits of the input gray level data uᵣ (i, j, k), are “1”, the carry-over is never induced by the subtraction of the state variable data xᵣ (i, j, k) from the lower bit data uᵣ^{L} (i, j, k). In this embodiment of n=8 and m=6, such the case corresponds to the case when

uᵣ (i, j, k)=“00000111”.

In FIG. 17, the fact that the carry-over is never induced is indicated by the symbol “−”.

Case 3

Case 3 is the case when all of the upper m bits of the input gray level data uᵣ (i, j, k) are at “0” and at least one of the low order (n−m) bits of the input gray level data uᵣ (i, j, k) is at “1”. In this embodiment of n=8 and m=6, Case 3 implies the case when

uᵣ (i, j, k)=“000000”,

and

uᵣ(i, j, k)≠“00000000”.

When the input gray level data uᵣ (i, j, k) is given by the decimal notation, Case 3 is the case when

1≦uᵣ (i, j, k)≦2^{(n-m)}−1.

In this embodiment of n=8 and m=6, this means

1≦uᵣ (i, j, k)≦3.

Case 3 is further classified into the following two cases, depending on the carry data CRYᵣ (i, j, k).

Case 3-1

Case 3 is the case when the carry data CRYᵣ (i, j, k) is “0”. In Case 3, the upper bit data yᵣ^{H} (i, j, k), which is the upper (m−1) bits of the pseudo gray level data yᵣ (i, j, k), is given by

yᵣ^{H} (i, j, k)=uᵣ^{H2} (i, j, k),

where uᵣ^{H2} (i, j, k) is the upper (m−1) bits of the input gray level data uᵣ (i, j, k). In this embodiment, the upper bit data yᵣ^{H} is given by

yᵣ^{H} (i, j, k)=“00000”.

Moreover, the least significant bit data yᵣ^{LSB} (i, j, k) that is the least significant bit of the pseudo gray level data yᵣ (i, j, k) is given by:

yᵣ^{LSB} (i, j, k)=Wᵣ

As mentioned above, the value Wᵣ is the value stored in the counter 37a. The value Wᵣ is toggled each time the LSB yᵣ^{LSB} (i, j, k) is generated on the basis of the value Wᵣ. Thus, the LSB yᵣ^{LSB} (i, j, k) becomes at “0” at the rate of once every two times, and becomes at “1” at the rate of once every two times.

Case 3-2

Case 3 is the case when the carry data CRYᵣ (i, j, k) is “1”. In Case 3, the pseudo gray level data yᵣ (i, j, k) is defined by

yᵣ (i, j, k)=uᵣ (i, j, k),

where uᵣ^{H1} (i, j, k) is the upper m bits of the input gray level data uᵣ (i, j, k), as mentioned above. In this embodiment, the pseudo gray level data yᵣ is given by

yᵣ (i, j, k)=“000000”.

When all the bits of the lower bit data uᵣ^{L} (i, j, k) are at “1”, the carry-over is never induced by the subtraction of the state variable data xᵣ (i, j, k) from the lower bit data uᵣ^{L} (i, j, k). In this embodiment of n=8 and m=6, this corresponds to the case when

uᵣ (i, j, k)=“00000011”.

In FIG. 17, the fact that the carry-over is never induced in the case when uᵣ (i, j, k)=“00000011” is indicated by the symbol “−”.

Case 4

Case 4 is the case when all of the bits of the input gray level data uᵣ (i, j, k) are at “0”. In the embodiment of n=8 and m=6, Case 4 implies the case when

uᵣ (i, j, k)=“00000000”.

When the input gray level data uᵣ (i, j, k) is given by the decimal notation, Case 4 is the case when

uᵣ (i, j, k)=0.

In Case 4, irrespectively of the carry data CRYᵣ (i, j, k), the pseudo gray level data yᵣ is defined by

yᵣ (i, j, k)=uᵣ^{H1} (i, j, k).

The uᵣ^{H1} (i, j, k) is the upper m bits of the input gray level data uᵣ (i, j, k). That is, in this embodiment, the pseudo gray level data yᵣ is given by

yᵣ (i, j, k)=“000000”.

The m-bit pseudo gray level data yᵣ (i, j, k) generated by the above-mentioned processes can indicate the 2ⁿ gray levels in the pseudo way.

In the second embodiment, also, the LCD 1 may be another display apparatus that is driven on the basis of the digitized input picture signal such as a PDP.

### Third Embodiment

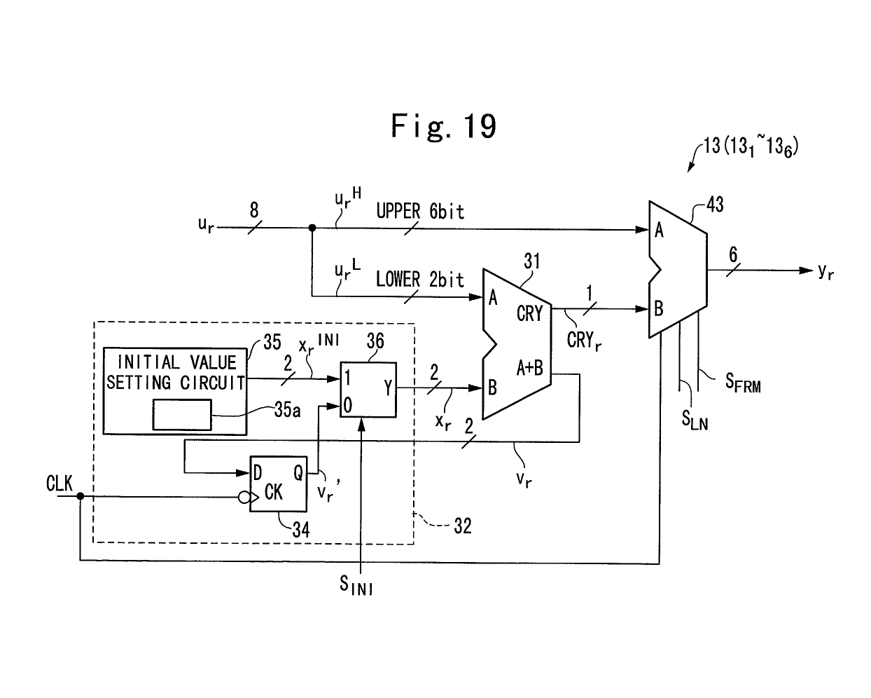

A display apparatus according to a third embodiment has the configuration similar to that of the display apparatus of the first embodiment. In the display apparatus of the third embodiment, the method of generating the pseudo gray level data yᵣ is different from that of the display apparatus of the first embodiment. In the third embodiment, the pseudo gray level processors 3₁-3₆ of the display apparatus in the first embodiment are replaced by pseudo gray level processors 13₁-13₆ shown in FIG. 19. The pseudo gray level processors 13₁-13₆ may be referred to as pseudo gray level processors 13.

The pseudo gray level processors 13 have the configuration similar to that of the pseudo gray level processors 3 in the first embodiment. The pseudo gray level processors 13 have the configuration in which the pseudo gray level data calculator 33 of the pseudo gray level processor 3 is replaced by a pseudo gray level data calculator 43. The pseudo gray level data calculator 33 and the pseudo gray level data calculator 43 carry out the operations different from each other, in the following points.

As mentioned above, the pseudo gray level data calculator 33 in the first embodiment sets the pseudo gray level data yᵣ^{LSB} to the value equal to the value W_{RA} stored in the counter 37a when the input gray level data uᵣ corresponding to Case 2-2 or 3-1 is inputted.

On the other hand, the pseudo gray level data calculator 43 in the third embodiment defines the pseudo gray level data yᵣ^{LSB} on the basis of a position of a pixel 8 whose gray level is specified by the input gray level data uᵣ, when the input gray level data uᵣ corresponding to the case 2-2 or 3-1 is inputted. The pseudo gray level data calculator 43 defines the pseudo gray level data yᵣ^{LSB} independently of each other for respective frames. That is, when the input gray level data uᵣ (i, j, k) corresponding to the case 2-2 or 3-1 is inputted, the pseudo gray level data calculator 43 defines the pseudo gray level data yᵣ^{LSB} on the basis of the affixes j, k.

The other configurations and operations of the display apparatus in the third embodiment are equal to those of the display apparatus in the first embodiment. The configuration and the operation of the pseudo gray level processors 13 in the third embodiment will be described in detail.

As shown in FIG. 19, the pseudo gray level processor 13 includes an adder 31, a state variable data generator 32. The adder 31 adds a lower bit data uᵣ^{L} and a state variable data xᵣ generated by the state variable data generator 32 to output the value vᵣ of (n−m) bits, where the lower bit data uᵣ^{L} is lower (n−m) bits of the input gray level data uᵣ.

Moreover, if the sum of the lower bit data uᵣ^{L} and the state variable data xᵣ results in the generation of the carry-over, the adder 31 sets a carry data CRYᵣ to “1” to output the pseudo gray level data calculator 43. If there is no generation of the carry-over, the adder 31 sets the carry data CRYᵣ to “0” to output to the pseudo gray level data calculator 43.

The state variable data generator 32 generates the state variable data xᵣ on the basis of the value vᵣ. An initial state variable data xᵣ^{INI} of the state variable data xᵣ is defined with reference with the initial value determiner ROM 35a having the content of the table shown in FIG. 6, similarly to the first embodiment. The process when the state variable data generator 32 generates the state variable data xᵣ is the same as the first embodiment.

The pseudo gray level data calculator 43 generates the pseudo gray level data yᵣ, on the basis of the upper bit data uᵣ^{H}, the carry data CRYᵣ, the clock signal CLK, the line management signal S_{LN} and the frame management signal S_{FRM}, as shown in FIG. 19. The line management signal S_{LN} indicates which of lateral lines 7 are enabled to activate the pixels 8. That is, the pseudo gray level data calculator 43 recognizes the affix j, on the basis of the line management signal S_{LN}. The frame management signal S_{FRM} indicates a frame of the inputted input gray level data uᵣ. That is, the pseudo gray level data calculator 43 recognizes the affix k on the basis of the frame management signal S_{FRM}.

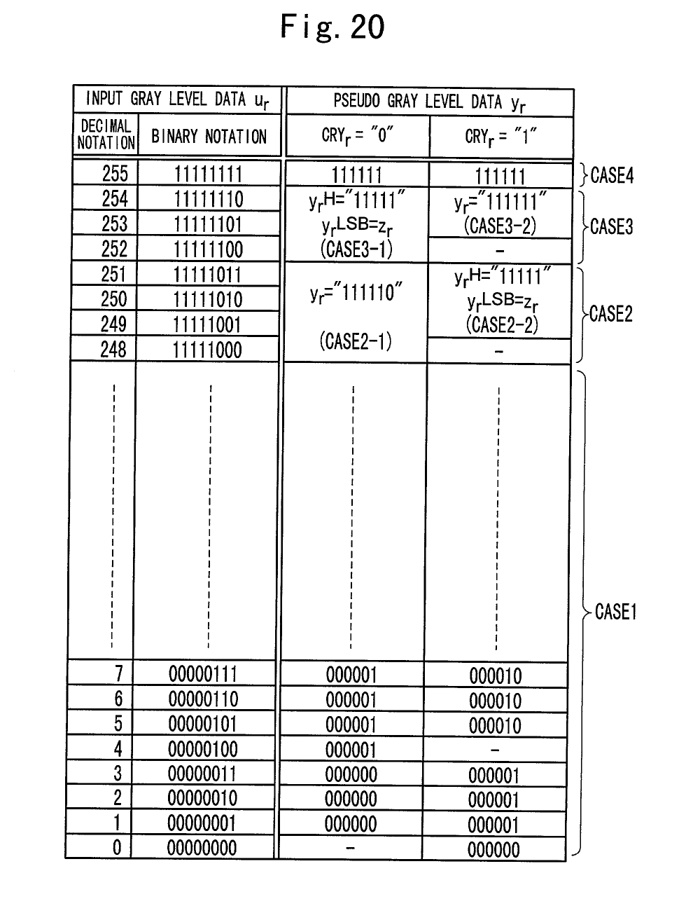

FIG. 20 is a truth table of the pseudo gray level data yᵣ (i, j, k) outputted by the pseudo gray level data calculator 43. The calculation carried out by the pseudo gray level data calculator 43 is classified into the following four cases.

Case 1

Case 1 is the case when at least one of the upper (m−1) bits of the input gray level data uᵣ (i, j, k) is at “0”.

Case 1 implies the case when uᵣ (i, j, k) in the decimal notation is given by

0≦uᵣ (i, j, k)≦2ⁿ−2^{(n-m+1)}−1.

In this embodiment of n=8 and m=6, Case 1 is the case when

0≦uᵣ (i, j, k)≦247.

In Case 1, the pseudo gray level data yᵣ (i, j, k) is defined by

yᵣ (i, j, k)=uᵣ^{H1} (i, j, k)+CRYᵣ (i, j, k)

where uᵣ^{H1} (i, j, k) is upper m bit of the input gray level data uᵣ (i, j, k).

Case 2

Case 2 is the case when all of the upper bits of the input gray level data uᵣ (i, j, k) are at “1” and an m-th significant bit of the input gray level data uᵣ (i, j, k) is at “0”. In the embodiment of n=8 and m=6, Case 2 implies the case when

uᵣ^{H1} (i, j, k)=“111110”,

When the input gray level data uᵣ (i, j, k) is given by the decimal notation, Case 2 is the case when

2ⁿ−2^{(n-m+1)}≦uᵣ (i, j, k)≦2ⁿ−2^{(n-m)}−1,

In this embodiment of n=8 and m=6, Case 2 is the case when

248≦uᵣ (i, j, k)≦251.

Case 2 is further classified into the following two cases, depending on the carry data CRYᵣ (i, j, k).

Case 2-1

Case 2-1 is the case when the carry data CRYᵣ (i, j, k) is “0”. In Case 2-1, the pseudo gray level data yᵣ (i, j, k) is defined by

yᵣ (i, j, k)=uᵣ^{H1} (i, j, k).

In this embodiment, the pseudo gray level data yᵣ is given by

yᵣ (i, j, k)=“111110”.

Case 2-2

Case 2-2 is the case when the carry data CRYᵣ (i, j, k) is “1”. In Case 2-2, the upper bit data yᵣ^{H} (i, j, k), which is the upper (m−1) bits of the pseudo gray level data yᵣ (i, j, k) is given by

yᵣ^{H} (i, j, k)=uᵣ^{H2} (i, j, k),

where uᵣ^{H2} (i, j, k) is the upper (m−1) bits of the input gray level data uᵣ (i, j, k).

The LSB yᵣ^{LSB} (i, j, k) of pseudo gray level data yᵣ (i, j, k) is obtained by

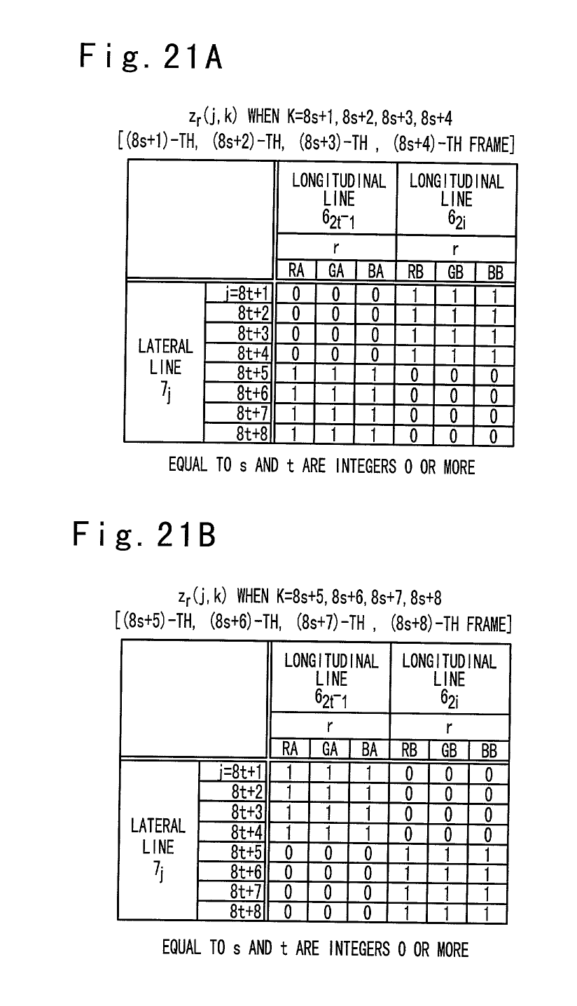

yᵣ^{LSB} (i, j, k)=zᵣ (i, j).

where zᵣ is defined as shown in FIGS. 21A, 21B.

With reference to FIG. 21A, when k is any of 8s+1, 8s+2, 8s+3 and 8s+4, and r is any of “RA”, “GA” and “BA” (s is an integer of 0 or more), the value zᵣ (i, k) is obtained by

zᵣ (j, k)=“0”,

for j being 8t+1, 8t+2, 8t+3 and 8t+4, where t is an integer of 0 or more.

In this case, the value zᵣ (i, k) is obtained for j being 8t+5, 8t+6, 8t+7 and 8t+8 by

zᵣ (j, k)=“1”.

When k is any of 8s+1, 8s+2, 8s+3 and 8s+4, and r is any of “RB”, “GB” and “BB”, the value zᵣ (j, k) is obtained by

zᵣ (j, k)=“1”,

for j being 8t+1, 8t+2, 8t+3 and 8t+4.

In this case, the value zᵣ (j, k) is obtained for j being 8t+5, 8t+6, 8t+7 and 8t+8 by

zᵣ(j, k)=“0”.

With reference to FIG. 21B, when k is any of 8s+5, 8s+6, 8s+7 and 8s+8, and r is any of “RA”, “GA” and “BA”, the value zᵣ (j, k) is obtained by

zᵣ (j, k)=“1”,

for j being 8t+1, 8t+2, 8t+3 and 8t+4, where t is an integer of 0 or more.

In this case, the value zᵣ (j, k) is obtained for j being 8t+5, 8t+6, 8t+7 and 8t+8 by

zᵣ (j, k)=“0”.

When k is any of 8s+5, 8s+6, 8s+7 and 8s+8, and r is any of “RB”, “GB” and “BB”, the value zᵣ (j, k) is obtained by

zᵣ (j, k)=“0”.

for j being 8t+1, 8t+2, 8t+3 and 8t+4, where t is an integer of 0 or more.

In this case, the value zᵣ (j, k) is obtained for j being 8t+5, 8t+6, 8t+7 and 8t+8 by

zᵣ (j, k)=“1”.

The value zᵣ (j, k) is different depending on whether r=“RA”, “GA” and “BA” or r=“RB”, “GB” and “BB”. This implies that zᵣ (j, k) is defined on the basis of a position of a pixel 8 in which a gray level is specified. At the time of r=“RA”, “GA” and “BA”, the pseudo gray level data yᵣ (i, j, k) specifies a gray level of a pixel 8_{2i-1, j} connected to an odd-numbered longitudinal line 6₂ᵢ₋₁. On the other hand, at the time of r=“RB”, “GB” and “BB”, the pseudo gray level data yᵣ (i, j, k) specifies a gray level of a pixel 8_{2i, j} connected to an odd-numbered longitudinal line 6₂ᵢ₋₁. In this way, the fact that zᵣ (j, k) is defined depending on whether r=“RA”, “GA” and “BA” or r=“RB”, “GB” and “BB” implies that the zᵣ (j, k) is defined depending on the specification of the gray level of the pixel 8₂ᵢ₋₁ connected to the odd-numbered longitudinal line 6₂ᵢ₋₁ or the specification of the gray level of the pixel 8₂ᵢ₋₁ connected to the even-numbered longitudinal line 6₂ᵢ₋₁. In this embodiment, zᵣ (j, k) does not depend on the affix i. The value zᵣ can be defined such that it depends on the affix i.

The value zᵣ (j, k) alternately has the values of “1” and “0” at a spatial period of four lateral lines 7. This corresponds to the fact that the initial state variable data xᵣ^{INI} generated by the above-mentioned initial value setting circuit 35 is designed so as to have the spatial period of the four lateral lines 7. The coincidence between the spatial period of zᵣ (j. k) and the initial state variable data xᵣ^{INI} allows the fixed pattern to be hard to be induced in the display of the LCD 1.

Moreover, zᵣ (j, k) is designed such that a number of pixels 8 in which the pseudo gray level data yᵣ are defined as being zᵣ (j, k)=“1” and a number of pixels 8 in which the pseudo gray level data yᵣ are defined as being zᵣ (j, k)=“1”. Also, zᵣ (j, k) is designed such that a region of the pixels 8 in which the pseudo gray level data yᵣ are defined as zᵣ (j, k) being “1” and a region of the pixels 8 in which the pseudo gray level data yᵣ are defined as zᵣ (j, k) being “0” alternately appear in a direction of an extension of the lateral line 7. Similarly, zᵣ (j, k) is designed such that the region of the pixels 8 in which the pseudo gray level data yᵣ are defined as zᵣ (j, k) being “1” and the region of the pixels 8 in which the pseudo gray level data yᵣ are defined as zᵣ (j, k)=being “0” alternately appear in a direction of an extension of the longitudinal line 6. This configuration reduced the color irregularity in the display of the LCD 1.

When all the bits of the lower bit data uᵣ^{L} (i, j, k), which are the lower (n−m) bits of the input gray level data uᵣ (i, j, k), are at “0”, the carry-over is never induced by the addition of the lower bit data uᵣ^{L} (i, j, k) and the state variable data xᵣ (i, j, k). In this embodiment of n=8 and m=6, this corresponds to the case when

uᵣ(i, j, k)=“11111000”.

In FIG. 20, the fact that the carry-over is never induced is indicated by the symbol “−”.

Case 3

Case 3 is the case when all of the upper m bits of the input gray level data uᵣ (i, j, k) are at “1” and at least one of the lower (n−m) bits of the input gray level data uᵣ (i, j, k) is at “0”. In the embodiment of n=8 and m=6, Case 3 implies the case when

uᵣ^{H1}(i, j, k)=“111111”,

and

uᵣ(i, j, k)≠“11111111”.

When the input gray level data uᵣ (i, j, k) is given by the decimal notation, Case 3 is the case when

2ⁿ−2^{(n-m)}≦uᵣ(i, j, k)≦2ⁿ−2.

In this embodiment of n=8 and m=6, Case 3 is the case when

252≦uᵣ (i, j, k)≦254.

Case 3 is further classified into the following two cases, depending on the carry data CRYᵣ (i, j, k).

Case 3-1

Case 3-1 is the case when the carry data CRYᵣ (i, j, k) is “0”. In Case 3-1, the upper bit data yᵣ^{H} (i, j, k), which is the upper (m−1) bits of the pseudo gray level data yᵣ (i, j, k), is given by

yᵣ^{H} (i, j, k)=uᵣ^{H2} (i, j, k),

where uᵣ^{H2} (i, j, k) is the upper (m−1) bits of the input gray level data uᵣ (i, j, k).

Moreover, the LSB of the pseudo gray level data yᵣ (i, j, k) is given by

yᵣ^{LSB} (i, j, k)=zᵣ (j, k).

where, zᵣ is the value defined as shown in the table of FIGS. 21A, 21B.

Case 3-2

Case 3-2 is the case when the carry data CRYᵣ (i, j, k) is “1”. In Case 3-2, the pseudo gray level data yᵣ (i, j, k) is defined by

yᵣ (i, j, k)=uᵣ^{H1} (i, j, k),

where uᵣ^{H1} (i, j, k) is the upper m bits of the input gray level data uᵣ (i, j, k). In this embodiment, the pseudo gray level data yᵣ is given by

yᵣ (i, j, k)=“111111”.

When all the bits of the lower bit data uᵣ^{L} (i, j, k) are at “0”, the carry-over is never induced by the addition of the lower bit data uᵣ^{L} (i, j, k) and the state variable data xᵣ (i, j, k). In this embodiment of n=8 and m=6, this corresponds the case when

uᵣ (i, j, k)=“11111100”.

In FIG. 20, the fact that the carry-over is never induced in the case when uᵣ (i, j, k)=“11111100” is indicated by the symbol “−”.

Case 4

Case 4 is the case when all of the bits of the input gray level data uᵣ (i, j, k) are at “1”. In the embodiment of n=8 and m=6, Case 4 implies the case when

uᵣ (i, j, k)=“11111111”.

When the input gray level data uᵣ (i, j, k) is given by the decimal notation, Case 4 is the case when

uᵣ (i, j, k)=2ⁿ−1.

In Case 4, irrespectively of the carry data CRYᵣ (i, j, k), the pseudo gray level data yᵣ is defined by

yᵣ(i, j, k)=uᵣ^{H1} (i, j, k).

where uᵣ^{H1} (i, j, k) is the upper m bits of the input gray level data uᵣ (i, j, k). That is, in this embodiment, the pseudo gray level data yᵣ is given by

yᵣ (i, j, k)=“111111”.

The m-bit pseudo gray level data yᵣ (i, j, k) generated as mentioned above can indicate the 2ⁿ gray levels in the pseudo way.

The process for generating the pseudo gray level data yᵣ (i, j, k) will be described below with regard to the input gray level data uᵣ (i, j, k) defined as being an actual value.

### Operation Example 3

In Operational Example 3, a process for generating the pseudo gray level data yᵣ during the first frame (k=1) is described when the input gray level data uᵣ is given by

uᵣ (i, j, 1)=“11111001”.

namely,

uᵣ (i, j, 1)=249.

As shown in FIG. 20, this is the case corresponding to Case 2. In this case, irrespectively of the carry data CRYᵣ, the upper bit data yᵣ^{H}, which is the upper (m−1) bits of the pseudo gray level data yᵣ, is given by

yᵣ^{H} (i, j, 1)=“11111”.

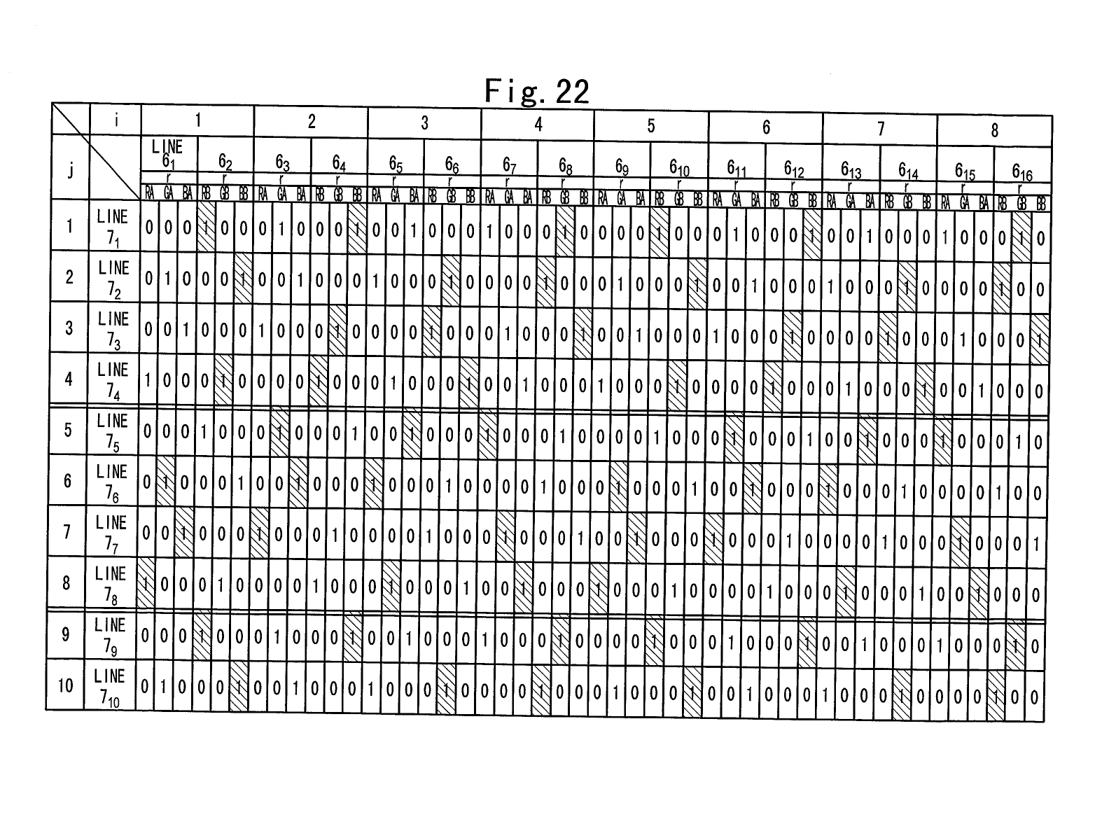

The LSB yᵣ^{LSB} (i, j, 1) of the pseudo gray level data yᵣ (i, j, 1) is defined as follows. FIG. 22 shows the carry data CRYᵣ (i, j, 1) and the LSB yᵣ^{LSB} (i, j, 1) when the input gray level data uᵣ is given by

uᵣ (i, j, 1)=“11111001”,

namely,

uᵣ (i, j, 1)=249.

In FIG. 22, similarly to FIGS. 10 and 12, the values “0” and “1” indicate that the carry data CRYᵣ (i, j, 1) are at “0” and “1”, respectively. Moreover, the fact that the values “0” and “1” are hatched in FIG. 22 implies that the least significant bit yᵣ^{LSB} (i, j, 1) is at “1”. Also, the fact that they are not hatched in FIG. 22 implies that the LSB yᵣ^{LSB} (i, j, 1) is at “0”.

The case when the carry data CRYᵣ (i, j, 1) is “0” corresponds to Case 2-1. In this case, the LSB yᵣ^{LSB} (i, j, 1) of the pseudo gray level data yᵣ is at “0”.

On the other hand, the case when the carry data CRYᵣ (i, j, 1) is “1” corresponds to Case 2-2. In this case, the LSB yᵣ^{LSB} (i, j, 1) is zᵣ (j, 1). Since k=1 in the first frame, zᵣ (j, 1) is defined in accordance with the table of FIG. 21A.

With reference to FIG. 21A, when r=“RA”, “GA” and “BA” and j=1, 2, 3 and 4, the value zᵣ (j, 1) is given by

zᵣ(j, 1)=“0”.

Thus, when r=“RA”, “GA” and “BA” and j=1, 2, 3 and 4, the LSB yᵣ^{LSB} (i, j, 1) is at “0” even if the carry data CRYᵣ (i, j, 1)=“1”.

For example, in a case of i=1, the carry data CRY_{RA}, CRY_{GA}, CRY_{BA}, the LSB y_{RA}^{LSB}, y_{GA}^{LSB}, and y_{BA}^{LSB} are given by:

CRY_{RA} (1, 4, 1)=“1”, y_{BA}^{LSB} (1, 4, 1)=“0”

CRY_{GA} (1, 2, 1)=“1”, y_{GA}^{LSB} (1, 2, 1)=“0”

CRY_{BA} (1, 3, 1)=“1”, y_{BA}^{LSB} (1, 3, 1)=“0”

On the other hand, when r=“RB”, “GB” and “BB” and j=1, 2, 3 and 4, with reference to FIG. 21A, the value zᵣ (j, 1) is given by

zᵣ(j, 1)=“1”

Thus, when r=“RB”, “GB” and “BB” and j=1, 2, 3 and 4 and the carry data CRYᵣ (i, j, 1) is “1”, the LSB yᵣ^{LSB} (i, j , 1) is at 1.

For example, in the case of i=1, the carry data CRY_{RB}, CRY_{GB}, CRY_{BB}, the LSB y_{RB}^{LSB}, y_{GB}^{LSB}, and y_{BB}^{LSB} are given by:

CRY_{RB} (1, 1, 1)=“1”, y_{RB}^{LSB} (1, 1, 1)=“1”

CRY_{GB} (1, 4, 1)=“1”, y_{GB}^{LSB} (1, 4, 1)=“1”

CRY_{BB} (1, 2, 1)=“1”, y_{BB}^{LSB} (1, 2, 1)=“1”

With regard to another r, i, j and k, the LSB yᵣ^{LSB} (i, j, k) are calculated in the same way.

### Operation Example 4

In an operational example 4, a process for generating the pseudo gray level data yᵣ during the first frame (k=1) is described when the input gray level data uᵣ is given by

uᵣ (i, j, 1)=“11111110”.

namely,

uᵣ (i, j, 1)=254.

As shown in FIG. 20, this is the case corresponding to Case 3. In Case 3, irrespectively of the carry data CRYᵣ, the upper bit data yᵣ^{H}, which is the upper (m−1) bits of the pseudo gray level data yᵣ, is given by:

yᵣ^{H} (i, j, 1)=“11111”.

The LSB yᵣ^{LSB} (i j, 1) of the pseudo gray level data yᵣ (i, j, 1) is defined as follows. FIG. 22 shows the carry data CRYᵣ (i, j, 1) and the least significant bit yᵣ^{LSB} (i, j, 1), when the input gray level data uᵣ is given by

uᵣ (i, j, 1)=“11111110”.

namely,

uᵣ (i, j, 1)=254.

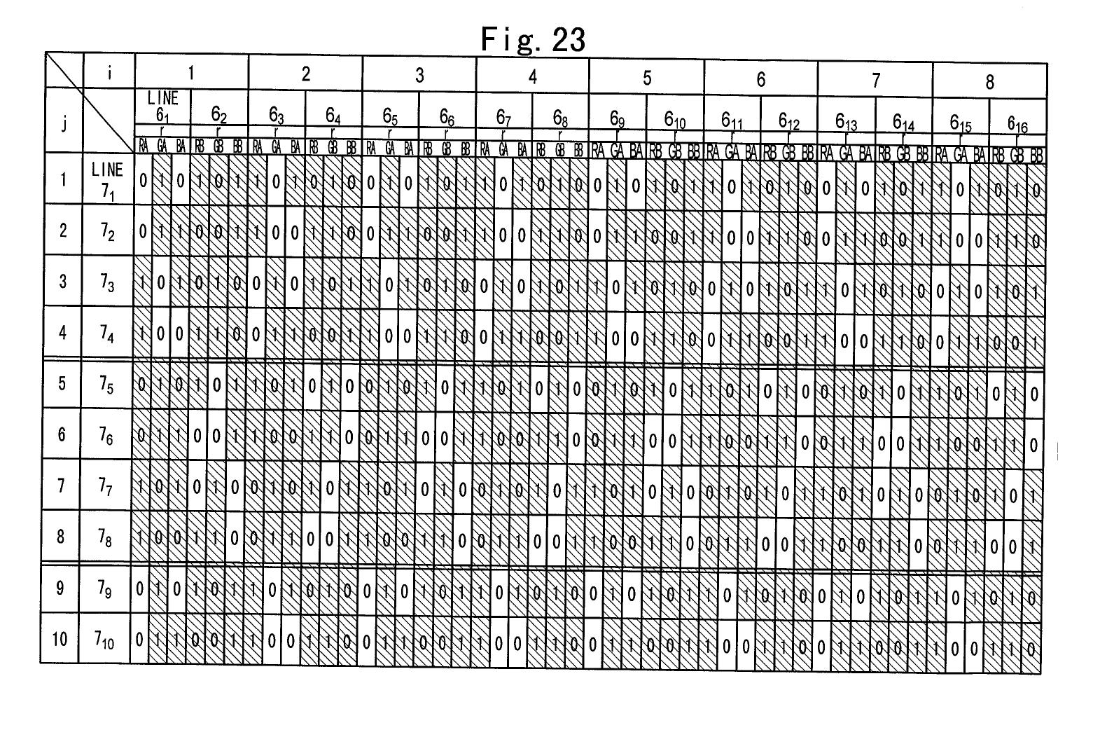

In FIG. 23, similarly to FIG. 22, the values “0” and “1” indicate that the carry data CRYᵣ (i, j, 1) are at “0” and “1”, respectively. Moreover, the fact that the values “0” and “1” are hatched in FIG. 23 implies that the least significant bit yᵣ^{LSB} (i, j, 1) is at “1”. Also, the fact that they are not hatched in FIG. 23 implies that the least significant bit yᵣ^{LSB} (i, j, 1) is at “0”.

The case when the carry data CRYᵣ (i, j, 1) is “0” corresponds to Case 3-1. In Case 3, the LSB yᵣ^{LSB} (i, j, 1) is zᵣ (j, 1) . Since k=1 in the first frame, zᵣ (j, 1) is defined in accordance with the table of FIG. 21A.

With reference to FIG. 21A, when r=“RA”, “GA” and “BA” and j=1, 2, 3 and 4, the value zᵣ (j, 1) is given by

zᵣ (j, 1)=“0”.

Thus, when r=“RA”, “GA” and “BA”, and j=1, 2, 3 and 4, and the carry data CRYᵣ (i, j, 1) is “0”, the LSB yᵣ^{LSB} (i, j, 1) is at “0”.

For example, in the case when i=1, the carry data CRY_{RA}, CRY_{GA}, CRY_{BA}, the LSB y_{RA}^{LSB}, y_{GA}^{LSB}, and y_{BA}^{LSB} are given by:

CRY_{RA} (1, 1, 1)=“0”, y_{RA}^{LSB} (1, 1, 1)=“0”,

CRY_{RA} (1, 2, 1)=“0”, y_{RA}^{LSB} (1, 2, 1)=“0”,

CRY_{GA} (1, 3, 1)=“0”, y_{GA}^{LSB} (1, 3, 1)=“0”,

CRY_{GA} (1, 4, 1)=“0”, y_{GA}^{LSB} (1, 4, 1)=“0”,

CRY_{BA} (1, 1, 1)=“0”, y_{BA}^{LSB} (1, 1, 1)=“0”,

CRY_{BA} (1, 4, 1)=“0”, y_{BA}^{LSB} (1, 4, 1)=“0”.

On the other hand, when r=“RB”, “GB” and “BB” and j=1, 2, 3 and 4, with reference to FIG. 21A, the value zᵣ is given by:

zᵣ (j, 1)=“1”.

Thus, when r=“RB”, “GB” and “BB” and j=1, 2, 3 and 4, even in the case when the carry data CRYᵣ (i, j, 1) is “0”, the LSB yᵣ^{LSB} (i, j, 1) is at “1”.

For example, in the case of i=1, the carry data CRY_{RB}, CRY_{GB}, CRY_{BB}, the LSB y_{RB}^{LSB}, y_{GB}^{LSB}, and y_{BB}^{LSB} are given by:

CRY_{RB} (1, 2, 1)=“0”, y_{RA}^{LSB} (1, 2, 1)=“1”,

CRY_{RB} (1, 3, 1)=“0”, y_{RA}^{LSB} (1, 3, 1)=“1”,

CRY_{GB} (1, 1, 1)=“0”, y_{GA}^{LSB} (1, 1, 1)=“1”,

CRY_{GB} (1, 2, 1)=“0”, y_{GA}^{LSB} (1, 2, 1)=“1”,

CRY_{BB} (1, 3, 1)=“0”, y_{BA}^{LSB} (1, 3, 1)=“1”,

CRY_{BB} (1, 4, 1)=“0”, y_{BA}^{LSB} (1, 4, 1)=“1”.

On the other hand, the case when the carry data CRYᵣ (i, j, 1) is “1” corresponds to Case 3-2. In Case 3-2, the LSB yᵣ^{LSB} (i, j, 1) is at “1”.

With regard to another r, j, k, and i, the LSB yᵣ^{LSB} (i, j, k) are calculated in the same way.

As mentioned above, the pseudo gray level processor 13 in the third embodiment allows the m-bit pseudo gray level data yᵣ (i, j, k) to indicate the 2ⁿ gray levels.

The pseudo gray level processor 13 in the third embodiment is desirable over the pseudo gray level processors 3 in the first and second embodiments, since the fixed pattern is hard to be induced in the display of the LCD 1. As described in the first embodiment, in the pseudo gray level process in the first embodiment, the initial state variable data xᵣ^{INI} is generated as shown in the table of FIG. 6 so that the fixed pattern is hard to be induced in the picture displayed on the LCD 1. However, if all the pixels 8 contained in the LCD 1 display the picture to be turned on in the gray level corresponding to Case 2 or 3 as explained in the operational examples 1 and 2, continuously over many frames, there may be a case of a generation of a stripe design of a fixed pattern. In this case, if the pseudo gray level process in the third embodiment is used, the fixed pattern is hard to be induced.

In the pseudo gray level processor 13 in the third embodiment, the LSB yᵣ^{LSB} (i, j, k) generated for Case 2-2 or Case 3-1 is defined on the basis of the position of the pixels 8 and the frame to which the input gray level data uᵣ (i, j, k) is inputted. In any one of the pixels 8, the least significant bit yᵣ^{LSB} (i, j, k) is changed for each four frames. Thus, the fixed pattern is hard to be induced in the display of the LCD 1.

As described above, the m-bit pseudo gray level data yᵣ (i, j, k) generated by the pseudo gray level processor 13 in the third embodiment can indicate the 2ⁿ gray levels. Moreover, the least significant bit yᵣ^{LSB} (i, j, k) of the pseudo gray level data yᵣ (i, j, k) is defined as mentioned above. Thus, the fixed pattern is hard to be induced in the display of the LCD 1.

Also in the third embodiment, similarly to the first and second embodiments, the LCD 1 may be another display apparatus that is directly driven on the basis of the digitized input picture signal, for example, such as PDP

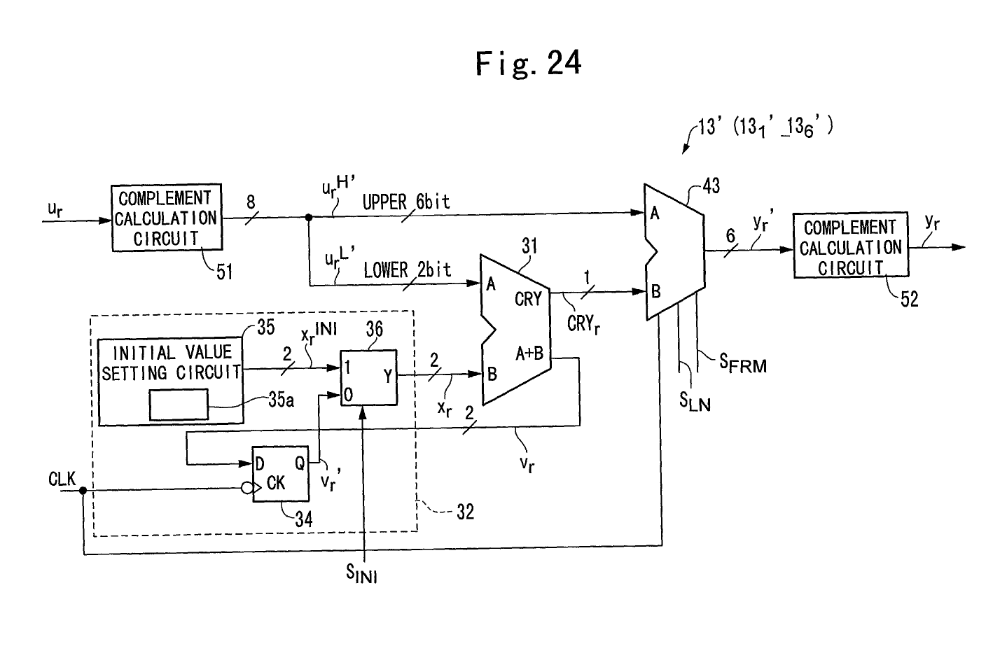

Moreover, in the third embodiment, the pseudo gray level processor 13 may be replaced by the pseudo gray level processor 13′ shown in FIG. 24. The pseudo gray level processor 13′ has the configuration in which the complement calculation circuits 51, 52 are added to the pseudo gray level processor 13. In this case, the pseudo gray level processor 13′ performs the calculation described in the third embodiment, on the complement of the input gray level data uᵣ, and calculates the complement pseudo gray level data yᵣ′. Moreover, the pseudo gray level processor 13′ obtains the complement of the complement pseudo gray level data yᵣ′, and calculates the pseudo gray level data yᵣ.

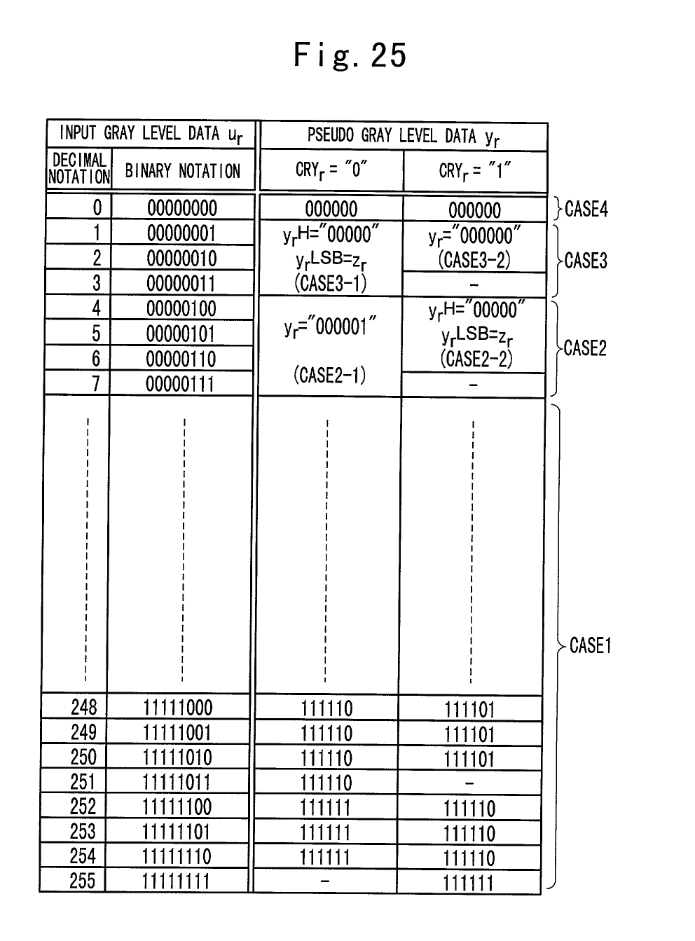

This corresponds to the operation in which all the additions done in the third embodiment are replaced by the subtractions. FIG. 25 shows the correspondence relation between the input gray level data uᵣ and the pseudo gray level data yᵣ in this case. Also, in this case, the m-bit pseudo gray level data yᵣ (i, j, k) generated by the pseudo gray level processor 13′ can indicate the 2ⁿ gray levels in the pseudo manner.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A display apparatus comprising:
a pseudo gray level data processor generating pseudo gray level data having m bits based on input gray level data having n bits representative of an input gray level of 2ⁿ gray levels, n being a natural number equal to or more than 2, and m being a natural number less than n, wherein
said pseudo gray level data processor includes:
a state variable generator generating a state variable data having n−m bits, based on lower n−m bits of said input gray level data,
an adder calculating a sum of said lower n−m bits of said input gray level data and said state variable data to output a carry bit representative of carry-over of said sum, and
a pseudo gray level data calculator generating said pseudo gray level data based on said input gray level data and said carry bit, and
said pseudo gray level data calculator defines said pseudo gray level data such that said pseudo gray level data equals upper m bits of said input gray level data in a first case when said carry bit is “0” and said input gray level belongs to first gray levels of said 2ⁿ gray levels, and such that upper m−1 bits of said pseudo gray level data equals upper m−1 bits of said input gray level data and the LSB (least significant bit) of said pseudo gray level data is selected from “0” and “1” in a second case when said carry bit is “1” and said input gray level data belongs to said first gray levels.

2. The display apparatus according to claim 1, wherein upper m−1 bits of said input gray level data are “1” and the m-th significant bit of said input gray level data is “0” when said input gray level data represents any one of said first gray levels.

3. The display apparatus according to claim 1, wherein a first probability of said LSB of said pseudo gray level data being “0” in said second case substantially equals a second probability of said LSB of said pseudo gray level data being “1” in said second case.

4. The display apparatus according to claim 1, further comprising a pixel matrix unit including pixels displaying a displaying gray level indicated by said pseudo gray level data, wherein
said pseudo gray level data calculator determines said LSB of said pseudo gray level data in response to a position of said pixels in said pixel matrix unit.

5. The display apparatus according to claim 4, wherein said pixels includes first and second pixels, said first pixels displaying a first displaying gray level indicated by said pseudo gray level data having said LSB of “1” in said second case, said second pixels displaying a second displaying gray level indicated by said pseudo gray level data having said LSB of “0” in said second case, and
said pixel matrix unit includes a first area in which said first pixels are located and a second area in which said second pixels are located, and
said first and second area are alternately located in said pixel matrix unit.

6. The display apparatus according to claim 1, wherein said pseudo gray level data calculator defines said gray level data such that said pseudo gray level data equals upper m bits of said input gray level data in a third case when said carry bit is “1” and said input gray level belongs to second gray levels of said 2ⁿ gray levels other than said first gray levels, and such that upper m−1 bits of said pseudo gray level data equals upper m−1 bits of said input gray level data and said LSB of said pseudo gray level data is selected from “0” and “1” in a fourth case when said carry bit is “0” and said input gray level data belongs to said second gray levels.

7. The display apparatus according to claim 6, wherein upper m bits of said input gray level data are “1” and at least one of lower n−m bits of said input gray level data is “0” when said input gray level data represents any one of said second gray levels.

8. The display apparatus according to claim 6, wherein a third probability of said LSB of said pseudo gray level data being “0” in said fourth case substantially equals a fourth probability of said LSB of said pseudo gray level data being “1” in said fourth case.

9. The display apparatus according to claim 6, wherein said pseudo gray level data calculator defines said pseudo gray level data such that said pseudo gray level data equals a sum of said carry bit and upper m bits of said input gray level data in a fifth case when said input gray level does not belong to any of said first and second gray levels.

10. The display apparatus according to claim 1, wherein
x(1)=x_{INI},
and
x(i)=u_{L}(i−1)+x(i−1)
when i is an natural number equal to or more than 2, where u(i) is one of said input gray level data which is i-th inputted to said pseudo gray level data processor, and u_{L}(i) is lower n−m bits of u(i) x(i) is one of said state variant data which is produced in response to u(i), x_{INI} is a predetermined value.

11. A display apparatus comprising:
a pseudo gray level data processor generating pseudo gray level data having m bits based on input gray level data having n bits representative of an input gray level of 2ⁿ gray levels, n being a natural number equal to or more than 2, and m being a natural number less than n, wherein
said pseudo gray level data processor includes:
a state variable generator generating a state variable data having n−m bits, based on lower n−m bits of said input gray level data,
an adder calculating a sum of said lower n−m bits of said input gray level data and said state variable data to output a carry bit representative of carry-over of said sum, and
a pseudo gray level data calculator generating said pseudo gray level data based on said input gray level data and said carry bit, and
said pseudo gray level data calculator defines said pseudo gray level data such that said pseudo gray level data equals upper m bits of said input gray level data in a third case when said carry bit is “1” and said input gray level belongs to second gray levels of said 2ⁿ gray levels, and such that upper m−1 bits of said pseudo gray level data equals upper m−1 bits of said input gray level data and the LSB of said pseudo gray level data is selected from “0” and “1” in a fourth case when said carry bit is “0” and said input gray level data belongs to said second gray levels.

12. The display apparatus according to claim 11, wherein upper m bits of said input gray level data are “1” and at least one of lower n−m bits of said input gray level data is “0” when said input gray level data represents any one of said second gray levels.

13. The display apparatus according to claim 11, wherein a third probability of said LSB of said pseudo gray level data being “0” in said fourth case substantially equals a second probability of said LSB of said pseudo gray level data being “1” in said fourth case.

14. The display apparatus according to claim 10, wherein
x(1)=x_{INI},
and
x(i)=u_{L}(i−1)+x(i−1)
when i is an natural number equal to or more than 2, where u(i) is one of said input gray level data which is i-th inputted to said pseudo gray level data processor, and u_{L}(i) is lower n−m bits of u(i), x(i) is one of said state variant data which is produced in response to u(i), x_{INI} is a predetermined value.

15. A display apparatus comprising:
a pseudo gray level data processor generating pseudo gray level data having m bits based on input gray level data having n bits representative of an input gray level of 2ⁿ gray levels, n being a natural number equal to or more than 2, and m being a natural number less than n, wherein
said pseudo gray level data processor includes:
a state variable generator generating a state variable data having n−m bits, based on lower n−m bits of said input gray level data,
a subtracter calculating a difference said lower n−m bits of said input gray level data minus and said state variable data to output a carry bit representative of carry-over of said difference, and
a pseudo gray level data calculator generating said pseudo gray level data based on said input gray level data and said carry bit, and
said pseudo gray level data calculator defines said pseudo gray level data such that said pseudo gray level data equals upper m bits of said input gray level data in a first case when said carry bit is “0” and said input gray level belongs to first gray levels of said 2ⁿ gray levels, and such that upper m−1 bits of said pseudo gray level data equals upper m−1 bits of said input gray level data and the LSB of said pseudo gray level data is selected from “0” and “1” in a second case when said carry bit is “1” and said input gray level data belongs to said first gray levels.

16. The display apparatus according to claim 15, wherein said pseudo gray level data calculator defines said gray level data such that said pseudo gray level data equals upper m bits of said input gray level data in a third case when said carry bit is “1” and said input gray level belongs to second gray levels of said 2ⁿ gray levels other than said first gray levels, and such that upper m−1 bits of said pseudo gray level data equals upper m−1 bits of said input gray level data and said LSB of said pseudo gray level data is selected from “0” and “1” in a fourth case when said carry bit is “0” and said input gray level data belongs to said second gray levels.

17. The display apparatus according to claim 16, wherein said pseudo gray level data calculator defines said pseudo gray level data such that said pseudo gray level data equals a difference upper m bits of said input gray level data minus said carry bit in a fifth case when said input gray level does not belong to any of said first and second gray levels.

18. The display apparatus according to claim 15, wherein
x(1)=x_{INI},
and
x(i)=u_{L}(i−1)−x(i−1)
when i is an natural number equal to or more than 2, where u(i) is one of said input gray level data which is i-th inputted to said pseudo gray level data processor, and u_{L}(i) is lower n−m bits of u(i), x(i) is one of said state variant data which is produced in response to u(i), x_{INI} is a predetermined value.

19. A display apparatus comprising:
a pseudo gray level data processor generating pseudo gray level data having m bits based on input gray level data having n bits representative of an input gray level of 2ⁿ gray levels, n being a natural number equal to or more than 2, and m being a natural number less than n, wherein
said pseudo gray level data processor includes:
a state variable generator generating a state variable data having n−m bits, based on lower n−m bits of said input gray level data,
a subtracter calculating a difference said lower n−m bits of said input gray level data minus said state variable data to output a carry bit representative of carry-over of said difference, and
a pseudo gray level data calculator generating said pseudo gray level data based on said input gray level data and said carry bit, and
said pseudo gray level data calculator defines said pseudo gray level data such that said pseudo gray level data equals upper m bits of said input gray level data in a third case when said carry bit is “1” and said input gray level belongs to second gray levels of said 2ⁿ gray levels, and such that upper m−1 bits of said pseudo gray level data equals upper m−1 bits of said input gray level data and the LSB of said pseudo gray level data is selected from “0” and “1” in a fourth case when said carry bit is “0” and said input gray level data belongs to said second gray levels.

20. The display apparatus according to claim 19, wherein
x(1)=x_{INI},
and
x(i)=u_{L}(i−1)−x(i−1)
when i is an natural number equal to or more than 2, where u(i) is one of said input gray level data which is i-th inputted to said pseudo gray level data processor, and u_{L}(i) is lower n−m bits of u(i), x(i) is one of said state variant data which is produced in response to u(i), x_{INI} is a predetermined value.

21. A method of generating pseudo gray level data representative of pseudo gray level, comprising:
sequentially inputting input gray level data, each of which has n bits and is representative of an input gray level of 2ⁿ gray levels, n being a natural number equal to or more than 2, and
sequentially generating pseudo gray level data having m bits based on said input gray level data, m being a natural number less than n, wherein
said sequentially generating includes:
delaying work data having n−m bits by a duration substantially equal to a temporal interval at which said input gray level data is inputted to output state variable data,
calculating a sum of lower n−m bits of said input gray level data and said state variable data,
outputting said sum as said work data,
outputting a carry bit of said sum,
defining said pseudo gray level data such that said pseudo gray level data equals upper m bits of said input gray level data in a first case when said carry bit is “0” and said input gray level belongs to first gray levels of said 2ⁿ gray levels, and
defining said pseudo gray level data such that upper m−1 bits of said pseudo gray level data equals upper m−1 bits of said input gray level data and the LSB of said pseudo gray level data is selected from “0” and “1” in a second case when said carry bit is “1” and said input gray level data belongs to said first gray levels.

22. The method of generating pseudo gray level data representative of pseudo gray level, comprising:
sequentially inputting input gray level data, each of which has n bits and is representative of an input gray level of 2ⁿ gray levels, n being a natural number equal to or more than 2, and
sequentially generating pseudo gray level data having m bits based on said input gray level data, m being a natural number less than n, wherein
said sequentially generating includes:
delaying work data having n−m bits by a duration substantially equal to a temporal interval at which said input gray level data is inputted to output state variable data,
calculating a difference lower n−m bits of said input gray level data minus said state variable data,
outputting said difference as said work data,
outputting a carry bit of said difference,
defining said pseudo gray level data such that said pseudo gray level data equals upper m bits of said input gray level data in a first case when said carry bit is “0” and said input gray level belongs to first gray levels of said 2ⁿ gray levels, and
defining said pseudo gray level data such that upper m−1 bits of said pseudo gray level data equals upper m−1 bits of said input gray level data and the LSB of said pseudo gray level data is selected from “0” and “1” in a second case when said carry bit is “1” and said input gray level data belongs to said first gray levels.
